(19) United States
(12) Patent Application Publication
(10) Pub. No.: US 2024/0240522 A1
(43) Pub. Date: Jul. 18, 2024

(54) ADJUSTABLE MATERIAL HOIST

(71) Applicant: Tie Down, Inc., Atlanta, GA (US)

(72) Inventors: Mohammed Aamir, Atlanta, GA (US); Christopher Andrew McDonnell, Atlanta, GA (US); Charles J. MacKarvich, Atlanta, GA (US)

(21) Appl. No.: 18/413,953

(22) Filed: Jan. 16, 2024

Related U.S. Application Data
(60) Provisional application No. 63/439,539, filed on Jan. 17, 2023.
(60) Provisional application No. 63/439,541, filed on Jan. 17, 2023.

(51) Int. Cl. E06C 7/12; B66B 9/193

(52) U.S. Cl. CPC E06C 7/12; B66B 9/193

(57) ABSTRACT

A method of using a material hoist system can include extending an overall length of a track assembly by slidably moving a second track member of the track assembly with respect to a first track member of the track assembly; and slidably moving a carriage of the system with respect to the track assembly.

### REFERENCE TO RELATED APPLICATIONS

This application claims the benefit of U.S. Provisional Application Nos. 63/439,539 and 63/439,541, filed Jan. 17, 2023, each of which is hereby specifically incorporated by reference herein in its entirety.

### TECHNICAL FIELD

### Field of Use

This disclosure relates to material hoist systems for transporting objects from one position to another, e.g., from a ground surface to an elevated surface. More specifically, this disclosure relates to material hoist systems configured to hoist objects on coupled track members from a lower position to a higher position with a motorized drive.

### Related Art

Ladders are commonly used to allow workers to reach portions of an elevated structure not otherwise accessible. Ladders, however, are not ideal for transport of material because a user must steady himself against the ladder and cannot simultaneously carry a heavy load. Something like a portable ladder, however, can be useful when access is needed only temporarily such as, for example only, to perform occasional maintenance and repair. Without a system to repeatedly and safely lift heavy materials, however, a user is left with relatively unsafe and burdensome options. Even where options may exist, accommodating for and safely reaching elevated structures at different heights can be difficult.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a track assembly comprising: a first track member; and a second track member slidably coupled to the first track member, each of the first track member and the second track member comprising: a first rail; and a second rail, each of the first rail and the second rail defining a first end and a second end distal from the first end, each of the first rail and the second rail comprising an I-beam, the I-beam extending along a longitudinal length of the track member, the I-beam comprising: a web defining a first edge and a second edge distal from the first edge; a first flange intersecting the first edge of the web; and a second flange intersecting the second edge of the web; and a plurality of rungs extending from the first rail to the second rail, the plurality of rungs spaced apart from each other and distributed along a longitudinal length of the corresponding track member; wherein: the first flange of the first rail of the first track member is in facing contact with the first flange of the first rail of the second track member; and the first flange of the second rail of the first track member is in facing contact with the first flange of the second rail of the second track member.

In a further aspect, disclosed is a carriage assembly comprising: a frame comprising: a first portion configured to slidably secure to a track member of a track assembly, the track assembly comprising: a first track member; and a second track member slidably coupled to the first track member; and a second portion coupled to the first portion and configured to be angled with respect to the first portion; and a plurality of moving elements secured to the frame.

In yet another aspect, disclosed is a method of using a material hoist system, the method comprising: extending an overall length of a track assembly by slidably moving a second track member of the track assembly with respect to a first track member of the track assembly; and slidably moving a carriage of the system with respect to the track assembly.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1A is a front perspective view of a material hoist system comprising a track assembly, a carriage assembly, and a drive assembly in accordance with one aspect of the current disclosure; wherein the track assembly comprises a first track member and a second track member coupled to the first track member, and wherein each of the carriage assembly and drive assembly are coupled to the track assembly proximate to a first end or bottom end of the track assembly.

FIG. 1B is a side view of the material hoist system of FIG. 1A in accordance with another aspect of the current disclosure.

FIG. 2 is an exploded front perspective view of the track assembly of FIG. 1A comprising a first track member, a second track member, a plurality of clamps configured to join the second track member to the first track member, and a guide assembly.

FIG. 3 is a rear detail perspective view of a second end or top end of the track assembly of FIG. 1A.

FIG. 4 is a rear exploded view of the guide assembly of FIG. 2.

FIG. 5 is a sectional view of the track assembly of FIG. 1A taken along line 5-5 of FIG. 1A.

FIG. 6A is a sectional view of the rail of the track assembly of FIG. 5 with other components removed for clarity.

FIG. 6B is a detail sectional view of the track assembly of FIG. 1 taken from detail 6B of FIG. 5.

FIG. 7 is a detail front perspective view of the track assembly of FIG. 1A taken from detail 7 of FIG. 1A showing a clamp of the track assembly.

FIG. 8A is a front perspective view of the clamp of FIG. 7.

FIG. 8B is a rear perspective view of the clamp of FIG. 7.

FIG. 8C is a front perspective view of the clamp of FIG. 7 in accordance with another aspect of the current disclosure.

FIG. 8D is a top view or end view of the clamp of FIG. 7.

FIG. 9 is a side perspective view of the carriage assembly of FIG. 1A.

FIG. 10 is a bottom perspective view of the carriage assembly of FIG. 1A.

FIG. 11 is a side view of the carriage assembly of FIG. 1A.

FIG. 12 is a rear view of the carriage assembly of FIG. 1A.

FIG. 13A is an outside perspective view of a moving element of the carriage assembly of FIG. 1A.

FIG. 13B is a side view of the moving element of FIG. 13A

FIG. 13C is an inside perspective view of a wheel of the moving element of FIG. 13A.

FIG. 13D is an outside perspective view of the wheel of FIG. 13C.

FIG. 14 is a sectional view of the moving element of FIG. 13A taken along line 14-14 of FIG. 11.

FIG. 15 is a bottom perspective view of the material hoist system of FIG. 1A showing the carriage assembly received about and engaged with the track assembly.

FIG. 16A is a detail bottom view of the material hoist system of FIG. 1A taken from detail 16A of FIG. 15.

FIG. 16B is a detail bottom view of the material hoist system of FIG. 1A taken from detail 16B of FIG. 16A.

FIG. 16C is a detail bottom view of the material hoist system of FIG. 1A taken from detail 16B of FIG. 16A and along line 16C-16C of FIG. 17A.

FIG. 16D is a detail bottom view of the material hoist system of FIG. 1A taken from detail 16B of FIG. 16A and along line 16D-16D of FIG. 17A.

FIG. 17A is a side view of the material hoist system of FIG. 1A showing the carriage assembly engaged with the track assembly, wherein the track assembly and, more specifically, the rails thereof are straight or rectilinear when viewed from the side.

FIG. 17B is a side view of the material hoist system of FIG. 1A showing the carriage assembly engaged with the track assembly, wherein the track assembly and, more specifically, the rails thereof are curved when viewed from the side.

FIG. 18 is a side view of a material hoist system comprising a track assembly, a carriage assembly, and a drive assembly in accordance with another aspect of the current disclosure, wherein the second portion of the carriage assembly is in a lowered or retracted position and a flexible connecting element extends from the drive assembly to the carriage assembly.

FIG. 19A is a side view of a material hoist system in a fully retracted position, the material hoist system comprising a track assembly, a carriage assembly, and a drive assembly in accordance with another aspect of the current disclosure; wherein the second portion of the carriage assembly is in a lowered or retracted position, the track assembly comprises a third track member rotatably coupled to the second track member, and the flexible connecting element is removed.

FIG. 19B is a side view of the material hoist system of FIG. 19A between the fully retracted position and an extended position.

FIG. 19C is a side view of the material hoist system of FIG. 19A with the third track member in the retracted position and the second track member in the extended position.

FIG. 19D is a side view of the material hoist system of FIG. 19A with the second track member in the retracted position and the third track member in the extended position.

FIG. 20A is a side perspective view of a hinge of the track assembly of FIG. 19A.

FIG. 20B is a side perspective view of the hinge of FIG. 20A during assembly to the second track member.

FIG. 21A is a side perspective view of a track assembly showing the hinge of the track assembly in a retracted position.

FIG. 21B is a side perspective view of the track assembly of FIG. 21A showing the hinge between the retracted position of FIG. 21A and an extended position shown in FIG. 21C.

FIG. 21C is a side perspective view of the track assembly of FIG. 21A showing the hinge in the extended position.

FIG. 22 is a side perspective view of a track lock assembly of the track assembly of FIG. 1A.

FIG. 23A is a side view of the material hoist system of FIG. 1A taken along line 23-23 of FIG. 1A showing the carriage assembly engaged with the track assembly at an area of transition from two track members to a single track member.

FIG. 23B is a side view of the material hoist system of FIG. 1A taken along line 23-23 of FIG. 1A showing the carriage assembly engaged with the track assembly at an area of the track assembly comprising only a single track member.

FIG. 24 is a front perspective view of the material hoist system of FIG. 1A with the carriage assembly positioned proximate to a second end or top end of the track assembly.

FIG. 25 is a front perspective view of a track member comprising a foot.

FIG. 26 is a partial sectional view of a rail for use in the track member of the track assembly and a moving element of the carriage assembly taken along line 5-5 of FIG. 1A, each of the rail and the moving element being in accordance with another aspect of the current disclosure.

FIG. 27 is an end view or side view of the moving element of FIG. 26.

FIG. 28 is a partial sectional view of the track assembly incorporating a plurality of each of the rail and the moving element of FIG. 26.

FIG. 29 is a partial sectional view of the track assembly and the carriage assembly taken along line 5-5 of FIG. 1A and similar to the detail 6B of FIG. 5, each of the track assembly and the carriage assembly being in accordance with yet another aspect of the current disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the material hoist system nearest to or occupied by a user of the system when facing a side of the track assembly from which a carriage assembly is configured to extend; “rear” is that end of the system that is opposite or distal the front; “left” is that which is to the left of or facing left from a person while facing towards the front; and “right” is that which is to the right of or facing right from that same person while facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

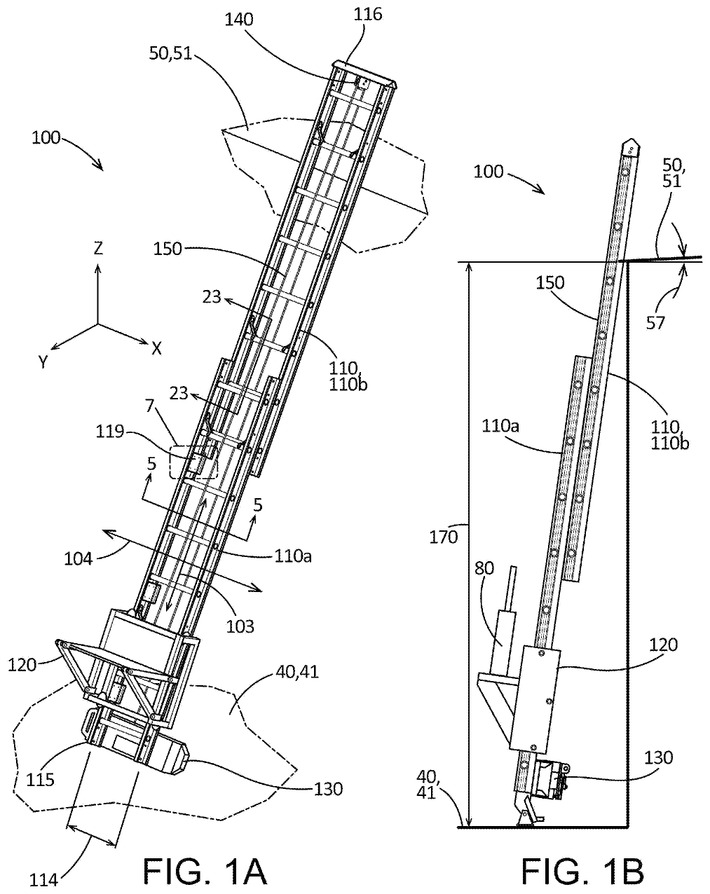

The material hoist system can also be described using a coordinate axis of X-Y-Z directions shown in FIG. 1A. An X-axis direction can be referred to as a left-right or horizontal direction. An upper-lower direction is a Z-axis direction orthogonal to the X-axis direction and to a Y-axis direction. The Y-axis direction is orthogonal to the X-axis direction (left-right direction) and the Z-axis direction (upper-lower direction) and can also be referred to as a front-rear direction. A surface of a structural element that is parallel with the front-rear direction can be referred to as a lateral side.

In various aspects, a material hoist system and associated methods, systems, devices, and various apparatuses are disclosed herein. In some aspects, the material hoist system can comprise a track assembly. In some aspects, the material hoist system can comprise a carriage assembly. In some aspects, the material hoist system can comprise a drive assembly.

FIG. 1A is a front perspective view of a material hoist system 100 in accordance with one aspect of the current disclosure. The material hoist system 100 can transport objects from one position to another position. In some aspects, for example, the material hoist system 100 can lift objects from a ground surface or first surface 41 of a first location or first position or first structure 40 to an elevated surface or second surface 51 of a second location or second position or second structure 50. In some aspects, the first position 40 can be a lower position and the second position 50 can be a higher position. In some aspects, the material hoist system 100 can transport objects between two elevated surfaces, which can be at or can define different heights.

The second structure 50, which can be an elevated structure, can be a roof of a structure such as a building. In some aspects, the surface 51 can be a roof surface. In some aspects, the second surface 51 can be another surface. In some aspects, the surface 51 can be a horizontal surface. In some aspects, as shown in FIG. 1B, the surface 51 can be sloped with respect to the horizontal by an angle 57. In some aspects, the angle 57 can measure 45 degrees or less. In some aspects, the angle 57 can measure 30 degrees or less. In some aspects, the angle 57 can measure 20 degrees or less. In some aspects, the angle 57 can measure 10 degrees or less. In some aspects, the angle 57 can measure 5 degrees or less.

More specifically, as shown, the system 100 can comprise an extension track or track extension assembly or track assembly or track 110 and can be configured to hoist objects, e.g., on the track assembly 110, from the first position 40 to the second position 50. The track assembly 110 can comprise a first track member 110a and a second track member 110b, which can be slidably coupled to the first track member 110a. The first track member 110a and the second track member 110b can be coupled to each other with one or more clamps 119. The second track member 110b can be configured to move or, more specifically, to slide in a longitudinal direction 103 of the track assembly 110. The second track member 110b can be configured to not move in a transverse or lateral direction 104 of the track assembly 110. In some aspects, the track assembly 110 can define a lateral width or width 114, which can be at least 18 inches.

The system 100 can comprise a carriage assembly or carriage assembly 120. As shown, the carriage assembly 120 can be coupled to the track assembly 110. As shown, the carriage assembly 120 can be slidably coupled to the track assembly. More specifically, the carriage assembly 120 can be coupled to the track assembly 110 proximate to a first end or bottom end 115 of the track assembly 110.

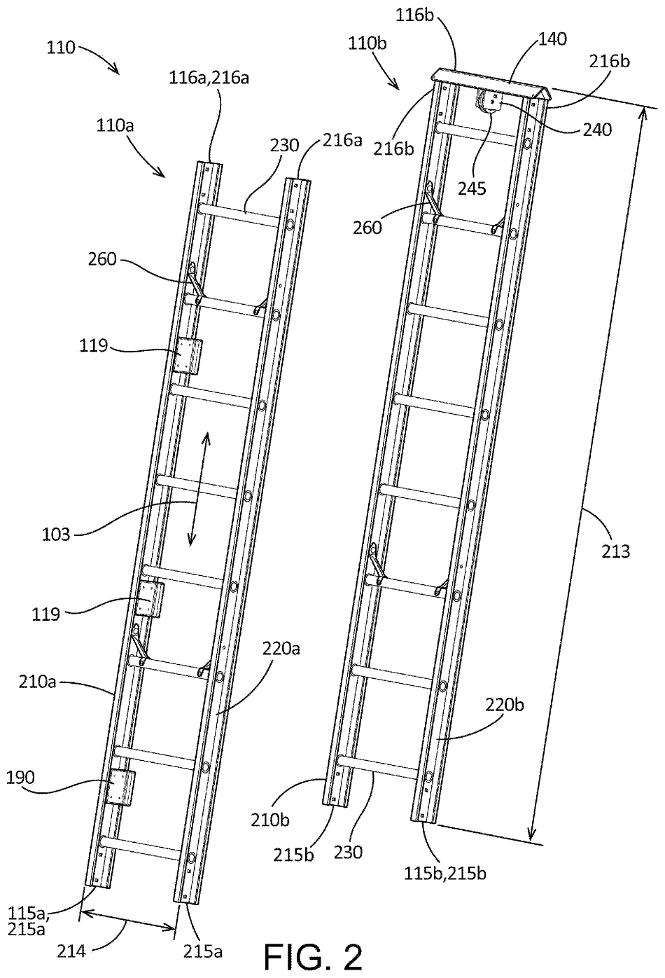

The system 100 can comprise a drive assembly or drive 130. As shown, the drive assembly 130 can be coupled to the track assembly 110. More specifically, the drive assembly 130 can be coupled to the track assembly 110 proximate to a bottom end or first end 115 of the track assembly 110. The drive assembly 130 can be configured to wind and unwind a flexible connecting element 150 (e.g., a cable or rope), which can be attached to the carriage assembly 120. The flexible connecting element 150 can be routed through an upper guide assembly or guide assembly 140 of the track assembly 110, which can be secured to a top end or second end 116 of the track assembly 110. The drive assembly 130 can be fixed in a stationary position on the track assembly 110 and can be configured to not move during operation of the system 100. More specifically, the drive assembly 130 can be fixed to the track assembly with any one or more of a variety of fasteners or other fastening structures (e.g., bolts and nuts, hooks, quick-release fasteners, and/or adhesive). In some aspects, the drive assembly 130 can be made smaller and can fit between a first beam or rail 210a,b (shown in FIG. 2) and a second beam or rail 220a,b (shown in FIG. 2) of the track assembly 110. Other details regarding the drive assembly 130 can be found in the co-pending U.S. Provisional Application No. 63/439,541 entitled DRIVE AND CARRIAGE FOR MATERIAL HOIST, filed by Applicant on Jan. 17, 2023, and incorporated by reference above.

FIG. 1B is a side perspective view of the material hoist system 100 of FIG. 1A in accordance with another aspect of the current disclosure. The carriage assembly 120 can carry any payload or load 80 that the user needs transported to the elevated surface 51, which can be offset from the first position 40 by a height 170. In some aspects, the system 100 can lift 250 pounds at 2 feet per second and has been so tested over 6,500 trips. For example and without limitation, the load 80 can be or can comprise construction tools or materials for use during building, renovation, or repair of the elevated structure 50 such as, for example and without limitation, power tools or roofing shingles.

FIG. 2 is an exploded front perspective view of the track assembly 110 of FIG. 1A. Again, the track assembly 110 can comprise the first track member 110a and the second track member 110b. The track assembly 110 can further comprise a plurality of the clamps 119, which can be configured to join the second track member 110b to the first track member 110a. Each of or either of the track members 110a,b can define the respective bottom end or first end 115a,b and the respective top end or second end 116a,b, which can be distal from the first end 115a,b.

Each of or either of the track members 110a,b can comprise the rail 210a,b and the rail 220a,b. Each of or either of the first rail 210a,b and the second rail 220a,b can define a first end 215a,b and a second end 216a,b, which can be distal from the first end 215a,b. As shown, the first rail 210a,b and the second rail 220a,b can be parallel to each other and to the longitudinal direction 103. In some aspects, as shown, one or more of the clamps 119 can be secured to the rails 210a,210b of the first track member 110a and can be configured to engage the second track member 110b.

Each of the first rails 210a,b and the second rails 220a,b can define a length 213, which in some aspects can be at least 4 feet. In some aspects, the length 213 of each of the first rails 210a,b and the second rails 220a,b and, more generally, each of the track members 110a,b can be at least 8 feet. In some aspects, the length 213 of each of the first rails 210a, b and the second rails 220a,b and, more generally, each of the track members 110a,b can be at least 12 feet. In some aspects, each of the first rails 210a,b and the second rails 220a,b can be formed monolithically. In some aspects, each of the first rails 210a,b and the second rails 220a,b can be formed from multiple pieces or sections, e.g., by fastening or welding. In some aspects, the lateral width 214 of the individual track members 110a,b can be 18 inches, plus or minus 6 inches. In some aspects, the lateral width 214 of the individual track members 110a,b can be shorter or greater than this distance or distance range.

Each of or either of the track members 110a,b can comprise a plurality of cross members or rungs 230, which can extend from the first rail 210a,b to the second rail 220a,b. The plurality of rungs 230 can be spaced apart from each other and distributed along the length 213 of the corresponding track member 110a,b. More specifically, each of or any of the rungs 230 can be secured to the first rail 210a,b or the second rail 220a,b by any useful fastening method such as mechanical crimping, welding, and/or separate fasteners. In some aspects, each of or any of the rungs 230 can be hollow. In some aspects, each of or either of the track members 110a,b can comprise one or more reinforcements 260, which can help maintain an angle between one of the plurality of rungs 230 and the first rail 210a,b and between one of the plurality of rungs 230 and the second rail 220a,b. Each of the plurality of rungs can define a circular shape in cross-section (or a shape that is substantially circular, meaning not considering surface texture such as, for example and without limitation, a non-smooth surface resulting from grooves defined in an outer surface of the rungs).

Again, the track assembly 110 can comprise the guide assembly 140, which can be secured to a track member such as, for example and without limitation, the second track member 110b. The guide assembly 140 can comprise a guide 240, which in some aspects can comprise a rotating element 245 such as, for example and without limitation, a pulley. The rotating element 245 can have rotational symmetry. In some aspects, the guide 240 can define a surface, which can be stationary, across which the flexible connecting element 150 (shown in FIG. 1A) can otherwise pass.

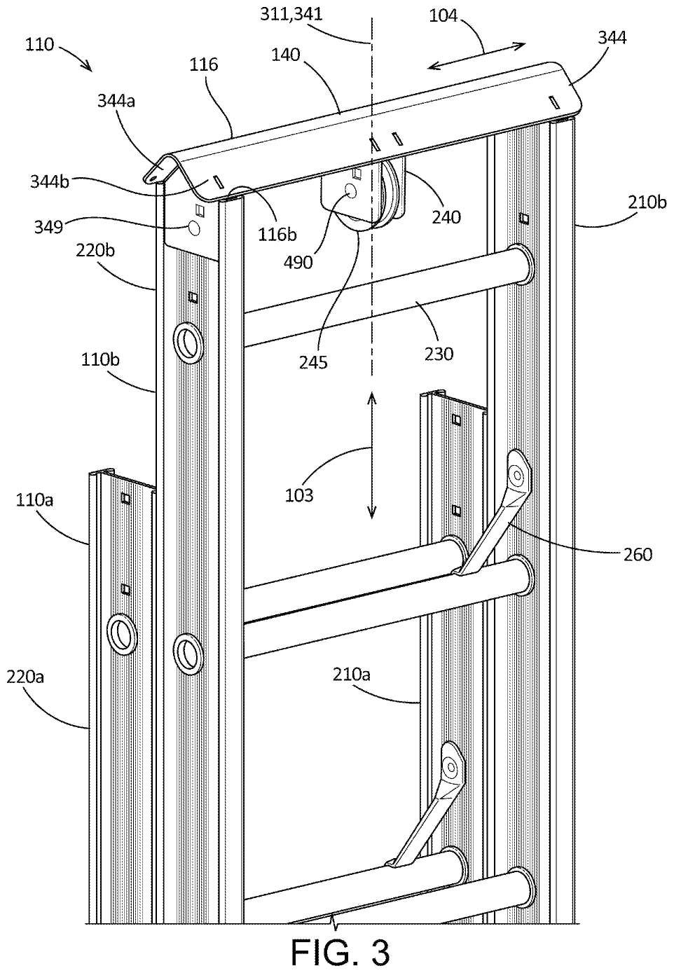

FIG. 3 is a rear detail perspective view of a second end or top end 116 of the track assembly 110 of FIG. 1A. The guide assembly 140, which again can be configured to guide passage of the flexible connecting element 150 (shown in FIG. 1A) therethrough, can be secured to the second end 116b of the second track member 110b. In some aspects, as shown, the guide assembly 140 can extend from the first rail 210b to the second rail 220b. In some aspects, the guide assembly 140 can extend from and can be secured to one of the rungs 230. As shown, the guide 240 and, more specifically, the rotating element 245 thereof can be positioned in or aligned along at least one axis with a centerline 341 of the guide assembly 140 and, more generally, a centerline 311 of the track assembly 110 along the lateral direction 104. The guide assembly 140 can be secured to each of the first rail 210b and the second rail 220b. More specifically, the guide assembly 140 can be secured to each of the first rail 210b and the second rail 220b with one or more fasteners 349 such as, for example and without limitation, bolt-and-nut combinations. The guide assembly can comprise a cap or base 344. The base 344, which can comprise a first panel 344a and a second panel 344b, can define a non-planar shape in which the second panel 344b is angled with respect to the first panel 344a. Such a non-planar shape can increase the rigidity of the base 344 and its resistance against bending under load (e.g., loading of the guide 240 and impact loads during transport of the track assembly 110). Each of or either of the panels 344a,b can be flat or planar except, for example, at an intersection therebetween.

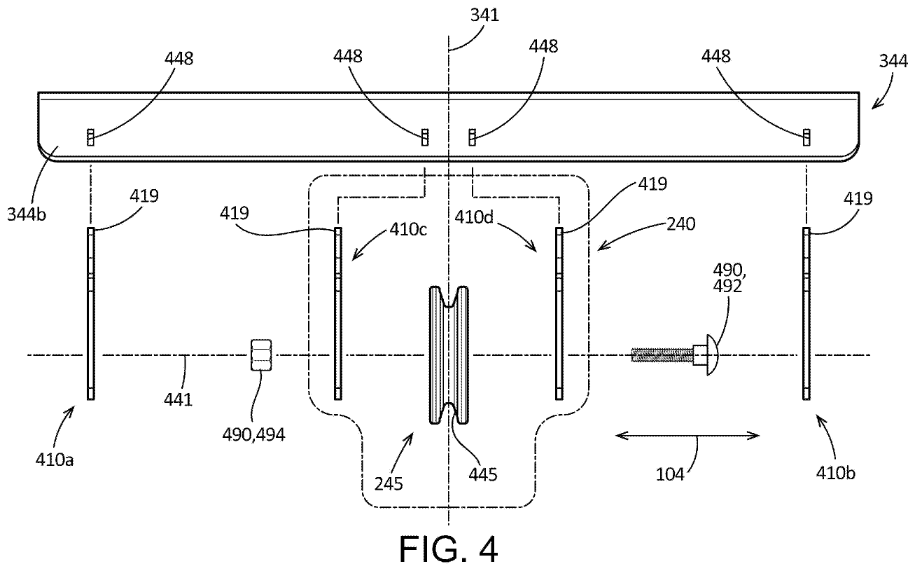

FIG. 4 is a rear exploded view of the guide assembly 140 of FIG. 2. The guide 240 can be secured to the base 344. The rotating element 245 can be secured to the guide 240. The guide 240 can comprise one or more panels or flanges such as side flanges 410a,b and guide flanges 410c, d. Each of or any of the flanges 410a,b,c,d can be flat. In some aspects, as shown, the flanges 410a,b,c,d can define identical or substantially identical detail (where “substantially identical” means identical in all aspects materially affecting function). Each of or any of the flanges 410a,b,c,d and, more specifically, tabs 419 thereof can be received within openings 448 defined in the base 344. Such interaction between the tabs 419 and the opening 448 can fix a position of each of or any of the flanges 410a,b,c,d in the lateral direction 104. The rotating element 245 can define a concave surface or a groove 445 in a radially outer surface, which can be sized and configured to receive the flexible connecting element 150 (shown in FIG. 1A) therein. The rotating element 245 and each of or any of the flanges 410a,b,c,d and, more specifically, openings defined therein can be configured to receive one or more mounting fasteners 490 (e.g., a bolt and nut combination or a clevis pin and cotter pin combination). More specifically, the mounting fasteners 490 can comprise a first portion 492 (e.g., a bolt, as shown, or a clevis pin) and a second portion 494 (e.g., a nut, as shown, or a cotter pin). Any two or more of the aforementioned components of the guide assembly 140 can be aligned along a guide axis 441, which can be aligned with the lateral direction 104. The rotating element 245 and, more generally, the guide 240 can be aligned with the centerline 341.

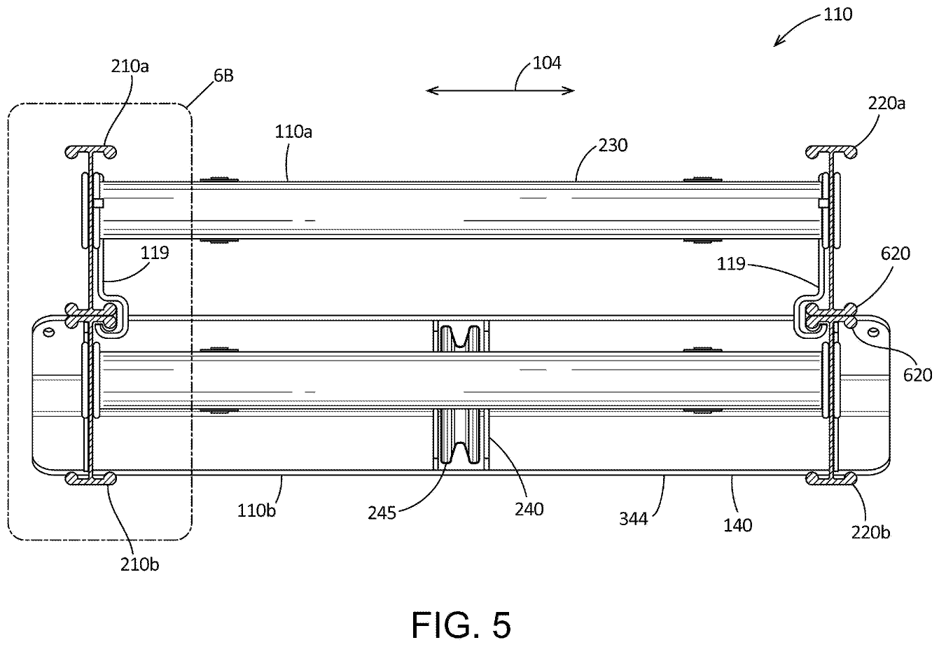

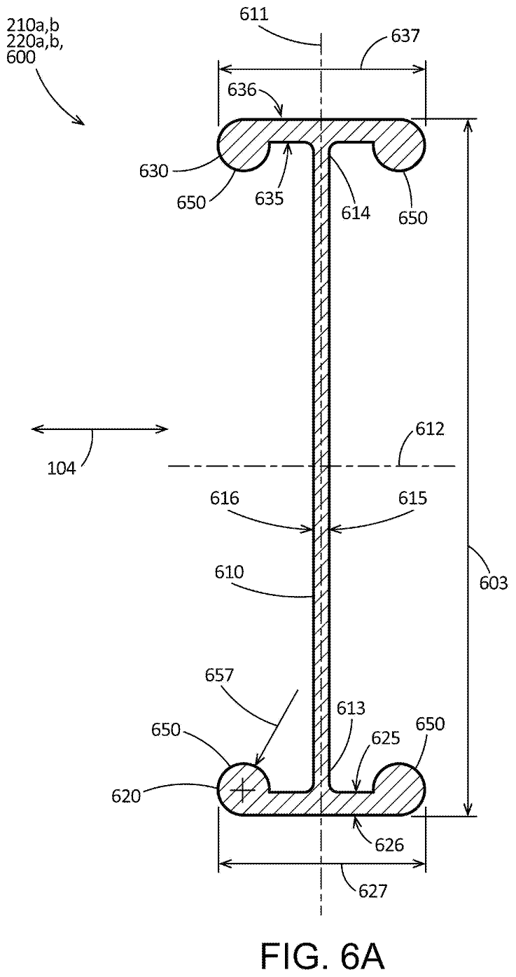

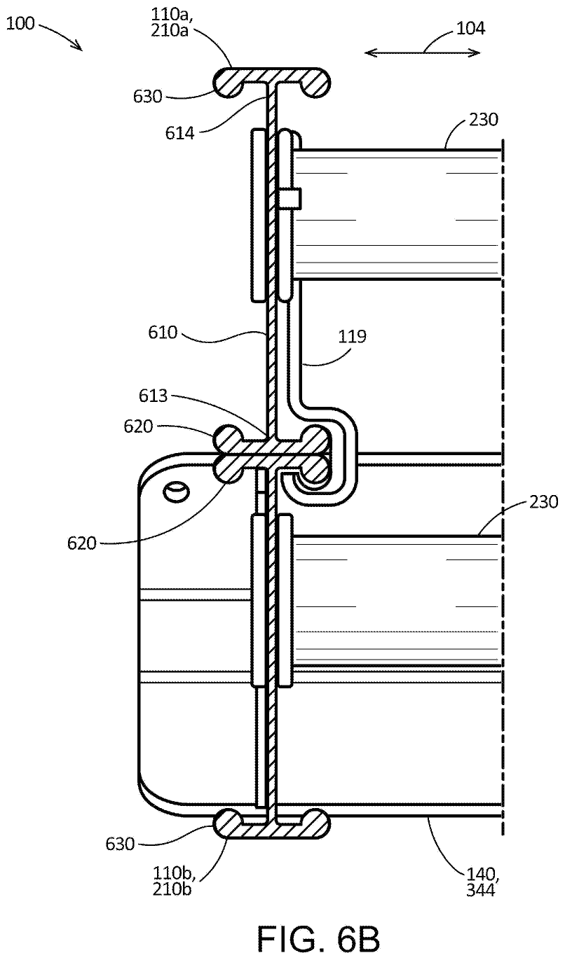

FIG. 5 is a sectional view of the track assembly 110 of FIG. 1A taken along line 5-5 of FIG. 1A, FIG. 6A is a sectional view of the track members 110a,b of the track assembly 110 of FIG. 5 with other components removed for clarity, and FIG. 6A is a detail sectional view of the track assembly 110 of FIG. 1A. Each of or any of the first rail 210a,b and the second rail 220a,b can comprise a beam. More specifically, in some aspects, each of or any of the first rail 210a,b and the second rail 220a,b can define a constant cross-section from the respective first end 115a,b to the respective second end 116a,b, not counting openings defined therein for receiving components such as, for example and without limitation, the rungs 230 or fasteners and, more generally, not counting modifications made after fabrication of the first rail 210a,b and the second rail 220a,b.

Each of or any of the first rail 210a,b and the second rail 220a,b can comprise a rail body 600. In some aspects, as shown in FIG. 6A, the rail body 600 can be or can define an I-beam or I-shaped beam. The rail body 600 can comprise a main member or web 610, which can define a vertical centerline 611 and can define a first edge 613 and a second edge 614 distal from the first edge 613. The rail body 600 can comprise a first flange 620, which can intersect or extend from the first edge 613 of the web 610. The rail body 600 can comprise a second flange 630, which can intersect or extend from the second edge 614 of the web 610. Each of or either of the flanges 620,630 can extend beyond the web 610 in the lateral direction 104 and can define flange widths 627,637. The rail body 600 can define an overall height 603. Each of or either of the flanges 620,630 can define bulbous portions or enlarged portions 650, each of which can define a radius 657. The web 610 can define an inboard surface 615 and an outboard surface 616. Either or each of the flanges 620,630 can define a respective inner surface 625,635 and a respective outer surface 626,636.

In some aspects, as shown, the rail body 600 can be symmetric about the vertical centerline 611. In some aspects, as shown, the rail body 600 can be symmetric about a transverse centerline 612. In some aspects, as shown, the rail body 600 can be symmetric about both of the centerlines 611,612. In some aspects, the rail body 600 need not display any symmetry. In some aspects, the rail body 600 can define a T-beam or T-shaped beam, in which case a single flange 620 can extend from the first edge 613 or the second edge 614 of the web 610. In some aspects, the rail body 600 can define a C-beam or C-shaped beam or C-channel.

As shown in FIG. 6B, the first flange 620 of the first rail 210a of the first track member 110a can be in facing contact with the first flange 620 of the first rail 210b of the second track member 110b. Similarly, as shown in FIG. 5, the first flange 620 of the second rail 220a (shown in FIG. 5) of the first track member 110a can be in facing contact with the first flange 620 of the second rail 220b (shown in FIG. 5) of the second track member 110b. When the rail body 600 is a T-beam, which can therefore lack the second flange 630, the single first flange 620 of the rail body 600 of each of the first rail 210a,b and the second rail 220a,b can contact each other.

As also shown in FIG. 6B, one of the clamps 119 can be configured to hold the first flange 620 of the first rail 210a of the first track member 110a in facing contact with the first flange 620 of the first rail 210b of the second track member 110b. Similarly, as shown in FIG. 5, another of the clamps 119 can be configured to hold the first flange 620 of the second rail 220a of the first track member 110a in facing contact with the first flange 620 of the second rail 220b of the second track member 110b.

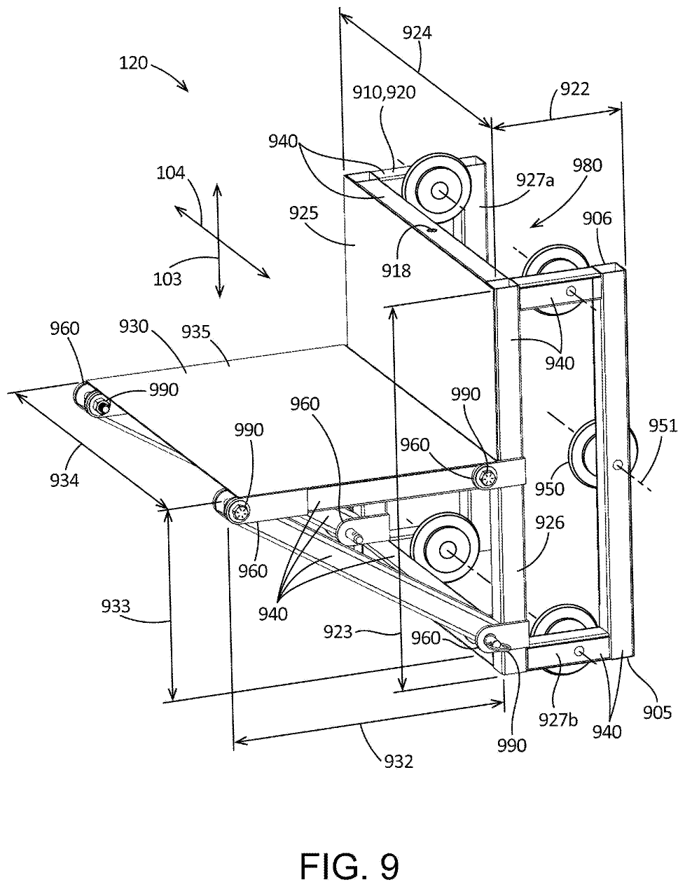

As shown in FIG. 9, the carriage assembly 120 can comprise a plurality of rotating elements or moving elements 950, each of which can be secured to the frame 910.

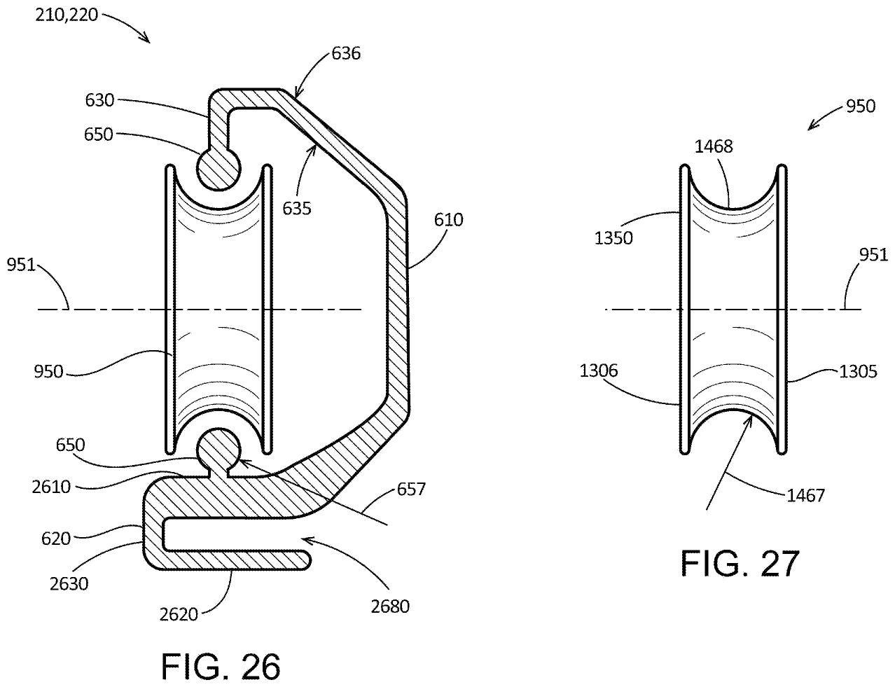

Skipping ahead, FIG. 26 is a partial sectional view of the rail 210,220 for use in the track member 110a,b of the track assembly 110 and the moving element 950 of the carriage assembly 120 taken along line 5-5 of FIG. 5, each of the rail 210,220 and the moving element 950 being in accordance with another aspect of the current disclosure. In some aspects, as shown, each of or either of the flanges 620 can comprise a curved shape in cross-section and can extend from the web 610 at an angle other than 90 degrees. In some aspects, a shape of the rail 210,220 can incorporate half of the rail body 600 shown in FIG. 6A by removing, for example, one half (e.g., an inboard half extending past the web 610 towards the right-hand side of FIG. 6A) of each of the first flange 620 and the second flange 630. In some aspects, as shown, the first flange can comprise a first portion 2610, a second portion 2620, and a connector 2630 joining the first portion 2610 and the second portion 2620. The first portion 2610 can be a first horizontal portion and can be aligned with or parallel to the lateral direction 104, the second portion 2620 can be a second horizontal portion and can be aligned with or parallel to the lateral direction 104, and the connector 2630 can be a vertical connector and can be perpendicular to the lateral direction 104. The first portion 2610 and the second portion 2620 can define a gap 2680 therebetween. For clarity, the remaining portions of the carriage assembly 120, which can comprise the moving elements 950, are not shown.

FIG. 27 is an end view or side view of the moving element 950 of FIG. 26. In some aspects, as shown, each of the moving elements 950 can comprise the wheel 1350, which can define an annular groove 1468.

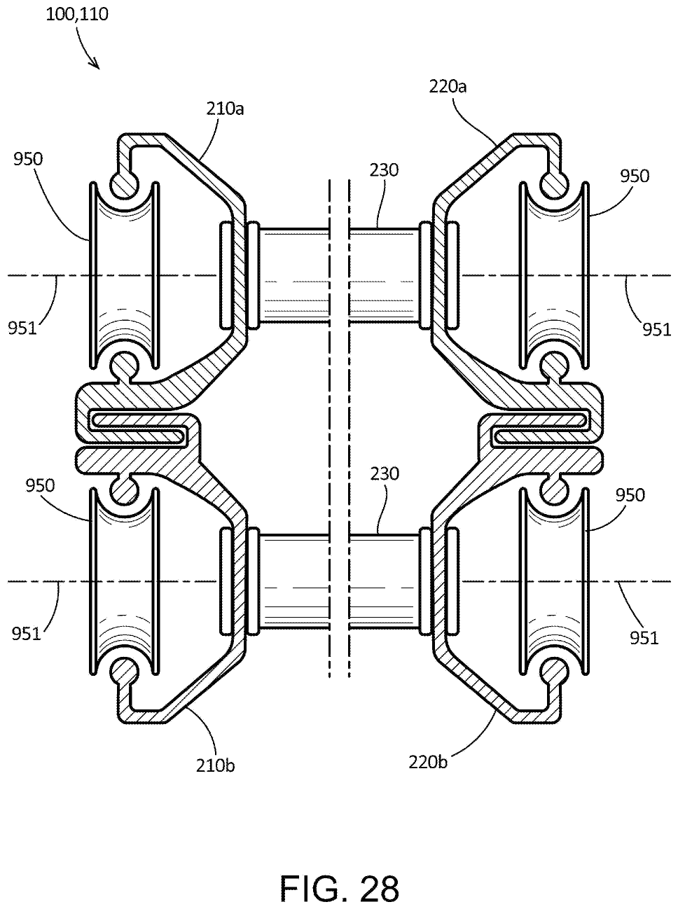

FIG. 28 is a partial sectional view of the track assembly 110 incorporating the rails 210,220 and the moving elements 950 of FIG. 26. Again, for clarity, the remaining portions of the carriage assembly 120, which can comprise the moving elements 950, are not shown.

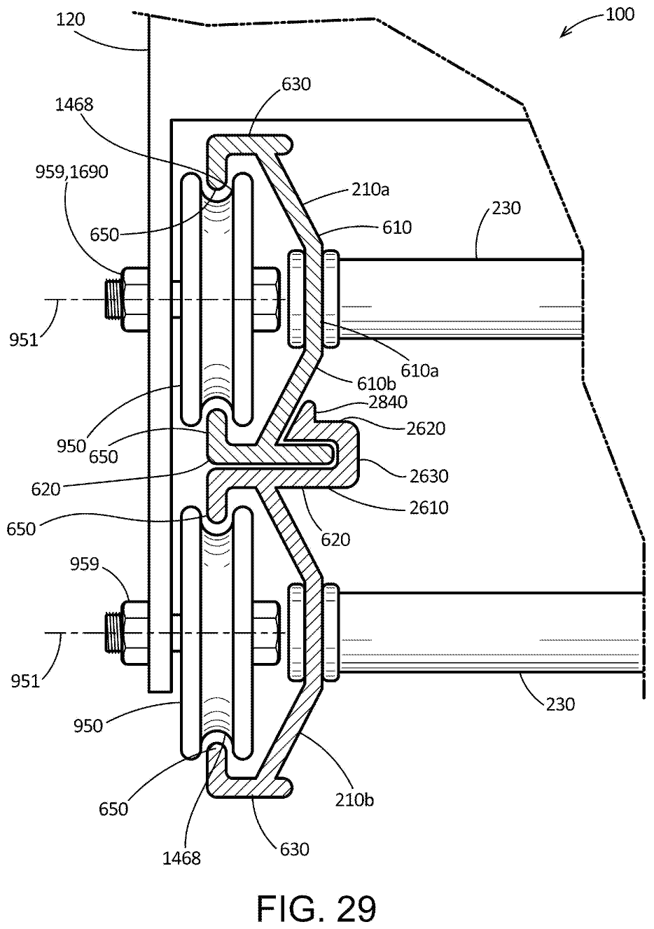

FIG. 29 is a partial sectional view of the track assembly 110 and the carriage assembly 120 taken along line 5-5 of FIG. 5 and similar to the detail 6B of FIG. 5, each of the track assembly 110 and the carriage assembly 120 being in accordance with yet another aspect of the current disclosure. In some aspects, again, each of or either of the flanges 620 can extend from the web 610 at an angle other than 90 degrees. In some aspects, the web 610 can comprise a first portion 610a and a second portions 610b extending from and angled with respect to (e.g., towards an outboard end or side of the track assembly 110) the first portion 610a. In some aspects, as shown, the first flange 620 can further comprise a fourth portion 2840, which can extend from the second portion 2620. More specifically, the fourth portion 2840 can contact the web 610. The fourth portion 2840 can be a vertical portion and can be perpendicular to the lateral direction 104. The first portion and the second portion 2630 can define the gap 2680 therebetween. In some aspects, as shown, the first rail 210a of the first track member 110a and the first rail 210b of the second track member 110b can vary in shape. As shown, the first rail 210 can comprise the first flange but without the second portion 2620, the connector 2630, or the fourth portion 2840. Each of or any of the moving elements 950 can be or can comprise the moving elements 950 shown in FIG. 27. In some aspects, in keeping with the structures disclosed herein, other shapes of the rail body 600 can be utilized.

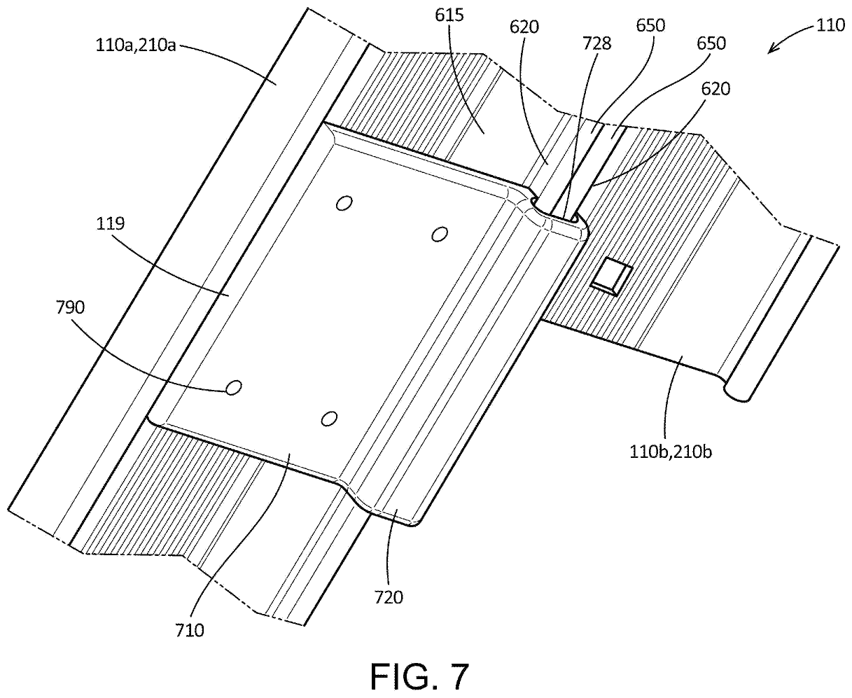

Skipping back, FIG. 7 is a detail front perspective view of the track assembly 110 of FIG. 1A taken from detail 7 of FIG. 1A showing the clamp 119 of the track assembly 110. As shown, the clamp 119 can be secured to the first rail 210a of the first track member 110a and can be engaged with the first rail 210b of the second track member 110b. Similarly, as shown in FIG. 5, the clamp 119 can be secured to the second rail 220a of the first track member 110a and can be engaged with the second rail 220b of the second track member 110b. More specifically, as shown, each of or any of the clamps 119 can be secured to the inboard surface 615 of the first rail 210a,b or the inboard surface 615 of the second rail 220a,b. Each of or any of the clamps 119 can be secured to the first rail 210a,b or the second rail 220a,b with one or more fasteners 790. In some aspects, each of the fasteners 790 can be any fastener configured to be removable such as, for example and without limitation, a bolt-and-nut combination. In some aspects, each of the fasteners 790 can be any fastener configured to be permanent (not removable without damage to the fastener 790 and/or the connection) such as, for example and without limitation, a rivet.

Each of or any of the clamps 119 can define a mounting portion 710 and an engagement portion 720. The engagement portion 720 can define an engagement feature 728, which can be or can define a groove or recess. As shown, exemplarily for either side of the track assembly 110, the engagement portion 720 and the engagement feature 728 can wrap around the enlarged portions 650 of the first flanges 620 of the first rails 210a,b. More specifically, as shown the engagement feature 728 can define a stadium, pill, or oblong shape in cross-section (or substantially so, not counting any opening in the shape to allow for passage of the flanges 620 of the first rails 210a,b or the second rails 220a,b).

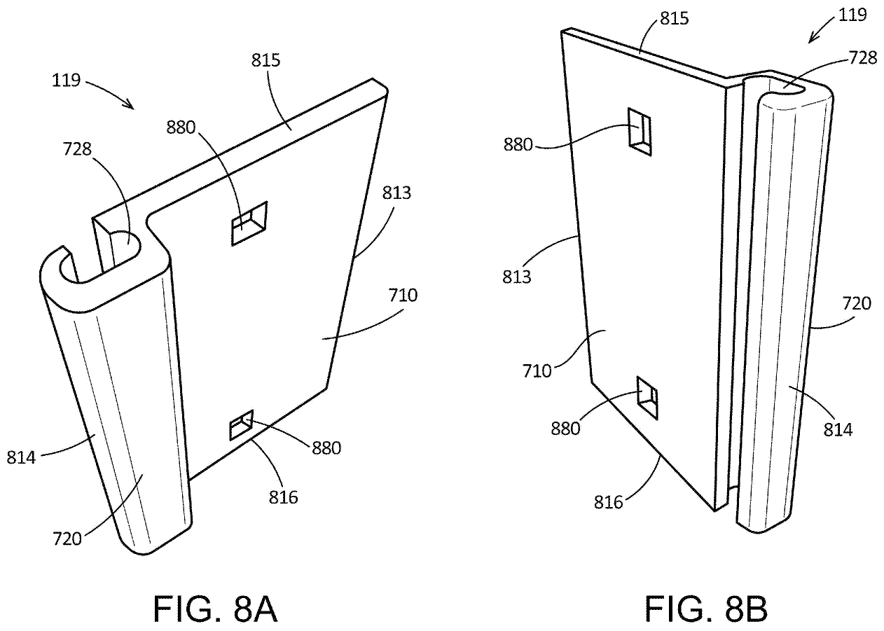

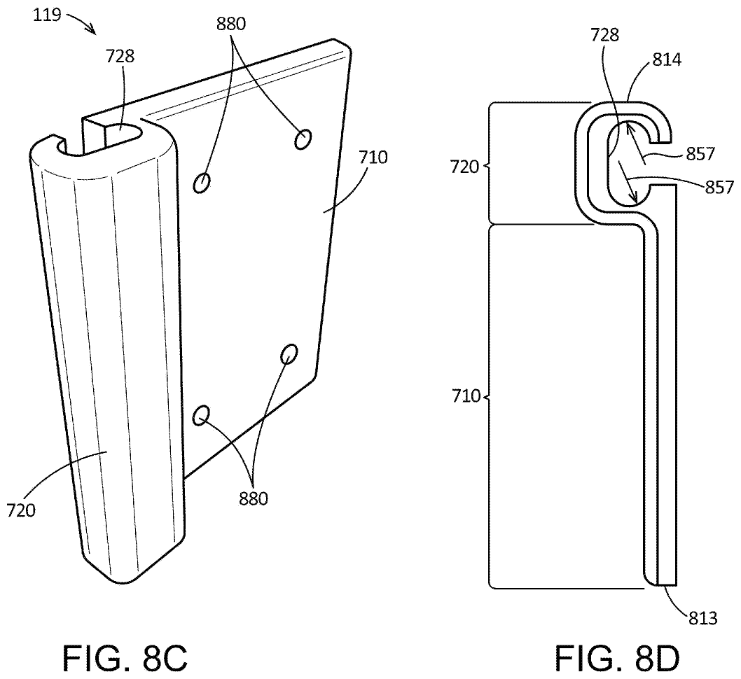

FIG. 8A is a front perspective view and FIG. 8B is a rear perspective view of the clamp 119 of FIG. 7. The clamp 119 can define a first side 813 defining the mounting portion 710, the second side 814 defining the engagement portion 720, a first end 815, and a second end 816. The clamp 119 and, more specifically, the mounting portion 710 thereof can define one or more openings 880, which can be sized to receive the fasteners 790 (shown in FIG. 7). In some aspects, as shown, each or any of the openings 880 can define a square shape, which can accommodate as desired instances of the fastener 790 comprising complementary geometry (e.g., a square shoulder under the head of a carriage bolt, which can engage the square shape of the opening 880 and thereby resist rotation even when tightened). In some aspects, as shown, the clamp 119 can specifically define a pair—or at least a pair—of the openings 880.

FIG. 8C is a front perspective view of the clamp 119 of FIG. 7 in accordance with another aspect of the current disclosure. In some aspects, as shown, each or any of the openings 880 can define a round shape. In some aspects, as shown, the clamp 119 can specifically define four—or at least four—of the openings 880.

FIG. 8D is a top view or end view of the clamp 119 of FIG. 7. In some aspects, at least a portion of the engagement feature 728 can define a radius 857. As shown, each radiused end of the engagement feature 728 when having the stadium shape in cross-section can define the radius 857. Edges of the clamp 119—and of another other component or assembly of the material hoist system 100—can define an edge treatment, e.g., a radius or chamfer, to facilitate manufacturability, ergonomics, and/or product safety. Walls of the clamp 119—and of another other component or assembly of the material hoist system 100—can likewise define, for similar or other reasons, a constant thickness or a substantially constant thickness (“substantially constant” meaning within an acceptable range for the manufacturing process used to manufacture the clamp 119 or other component or assembly). Each or any of the clamps can define a rectangular shape or substantially rectangular shape (meaning rectangular except in materially insignificant areas, e.g., edge or corner radii).

FIG. 9 is a side perspective view of the carriage or carriage assembly 120 of FIG. 1A. The carriage assembly 120 can comprise a frame 910 and can define a bottom end or first end 905 and a top end or second end 906. In some aspects, the frame 910 can comprise a first portion 920 and a second portion 930. In some aspects, the frame 910 can comprise only the first portion 920. The first portion 920 can be configured to slidably secure to a track member such as the track member 110a of the track assembly 110. The second portion 930 can be coupled to the first portion 920. The frame 910 and, more specifically, either or both of the first portion 920 and the second portion 930 can be formed from separate frame members 940, which can be joined together in various geometric arrangements as shown, including in arrangements in which the frame members 940 (which can be, e.g., vertical and horizontal members or longitudinal and lateral members) are angled at 90 degrees with respect to each other. In some aspects, the frame members 940 can be joined by welding. In some aspects, the frame members 940 can be joined by fasteners. Each of or any of the frame members can be rectilinear as shown. The first portion 920 of the frame 910 can define a depth 922, a longitudinal width 923, and a lateral width 924. Similarly, the second portion 930 of the frame 910 can define a depth 932, a longitudinal width 933, and a lateral width 934. Each of or either of the lateral widths 924,934 can be greater than the lateral width 114 (shown in FIG. 1A) of the track assembly 110 (shown in FIG. 1A) and, more specifically, the lateral width 214 (shown in FIG. 2) of the track members 110a,b (shown in FIG. 2) thereof.

In some aspects, as shown, the second portion 930 or a portion thereof can be angled—or can be configured to be angled—with respect to the first portion 920, which can help a user more conveniently place and optionally secure the load 80 (shown in FIG. 1B) on the carriage assembly 120. To help support the load 80, each of either of the first portion 920 or the second portion 930 can comprise a panel and/or can define a surface. As shown, for example and without limitation, the first portion 920 can comprise a panel 925 (e.g., a vertical panel or back panel), and the second portion 930 can comprise a panel 935 (e.g., a horizontal panel or shelf panel). In some aspects, as shown, each of or either of the panels 925,935 can be formed from a solid material. In some aspects, each of or either of the panels 925,935 can define openings (e.g., to save weight or to secure the load 80).

The frame 910 and, more specifically, the first portion 920 thereof can define a track cavity 980, which can be sized and configured to receive the track assembly 110 therein. More specifically, the first portion 920 can comprise a base 926 and legs 927a,b, which can extend from the base 926 and can be angled with respect to the base 926. As shown, the legs 927a,b can be angled at 90 degrees with respect to the base 926. As such, in some aspects, the first portion 920 of the frame 910 can, at least in part, define a C-shape when viewed along the longitudinal direction 103. Either of or each of the first portion 920 and the second portion 930 can define one or more lugs 960, each of or any of which can facilitate joining of the second portion 930 to the first portion 920. In some aspects, as shown, each of or any of the lugs 960 can be formed monolithically as part of another component such as one of the frame members 940. In some aspects, each of or any of the lugs 960 can be formed as a separate component and joined with a fastener and/or welding.

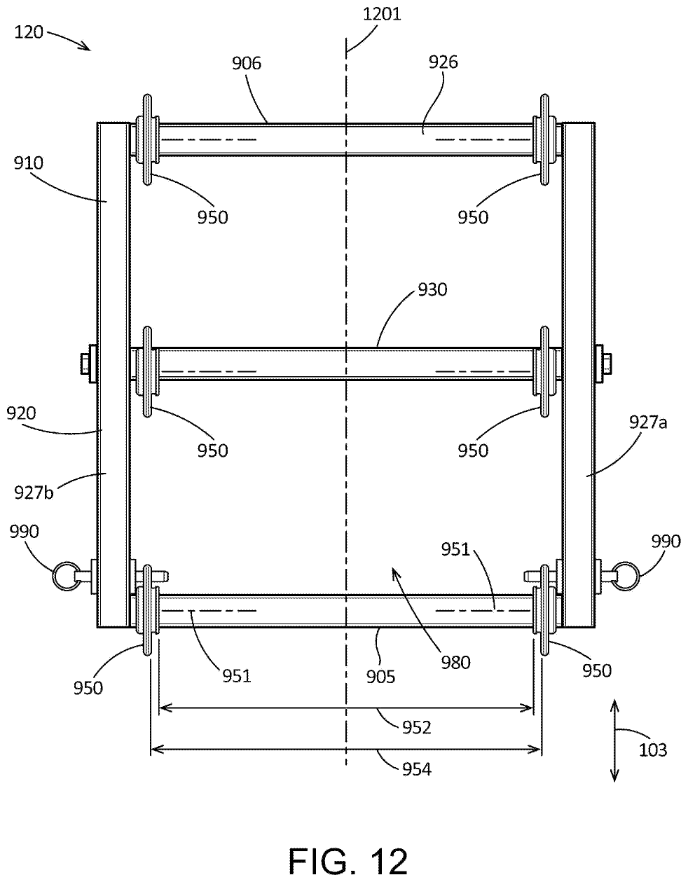

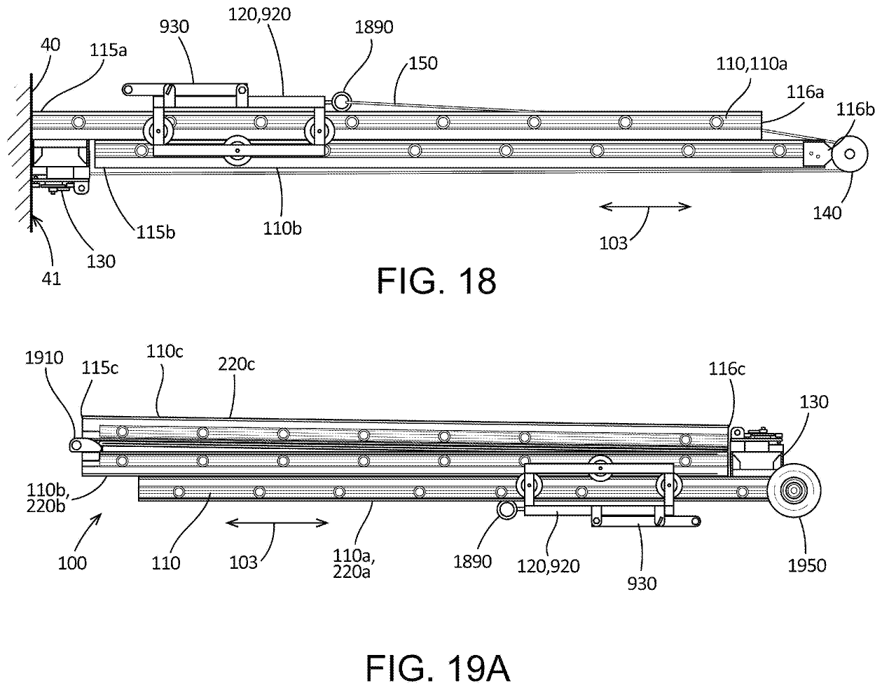

One or more fasteners 990 can couple the second portion 930 to the first portion 920. In some aspects, each of the fasteners 990 can be quick-release fasteners (i.e., a fastener not requiring a tool other than a user's hand to engage or disengage). In some aspects, each of the fasteners 990 can be any other connecting element such as, for example and without limitation, a bolt-and-nut combination. The frame 910 and, more specifically, the first portion 920 thereof can define an opening 918, which can receive the flexible connecting element 150 (shown in FIG. 1A) or an adapter 1890 (shown in FIG. 18, e.g., an eye bolt) configured to receive the flexible connecting element 150. The carriage assembly 120 and any one or more portions thereof (e.g., the frame 910) can be symmetric about a centerline 1201 (shown in FIG. 12) of the carriage assembly 120. The centerline 1201 can be aligned with the longitudinal direction 103.

Again, the carriage assembly 120 can comprise the plurality of moving elements 950, each of which can be secured to the frame 910. As shown, each of the plurality of moving elements 950 can be secured to an inside portion or surface of the legs 927a,b of the first portion 920 of the frame 910. An axis of each of or any of the plurality of moving elements 950 can be aligned with the lateral direction 104.

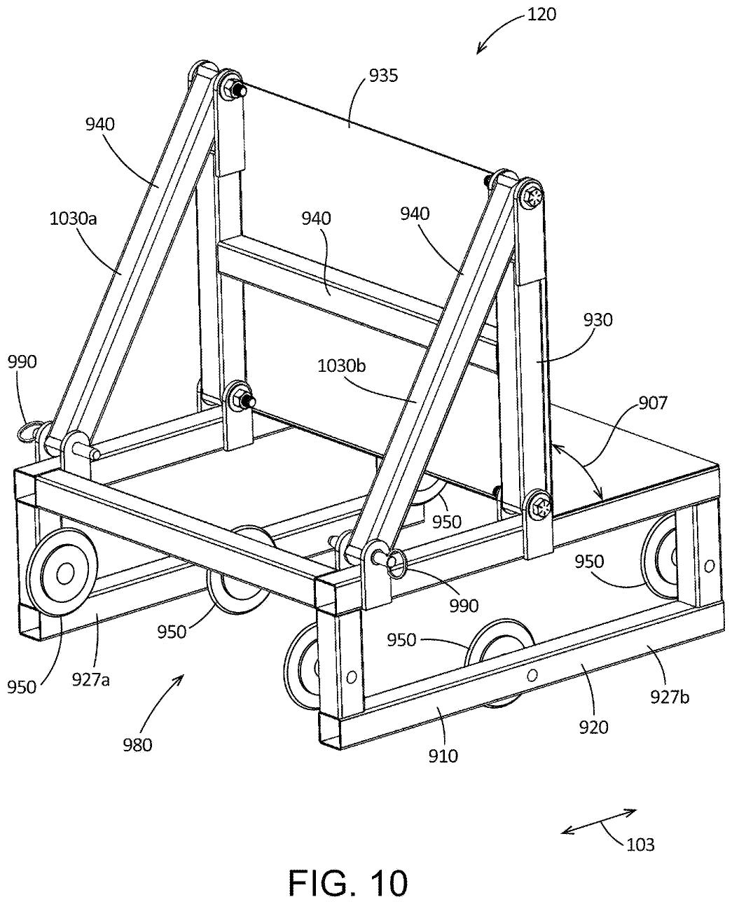

FIG. 10 is a bottom perspective view of the carriage assembly 120 of FIG. 1A. The frame 910 and, more specifically, the second portion 930 thereof can comprise one or more support members 1030a,b, which can maintain a position of the second portion 930 with respect to the first portion 920. The support members 1030a,b can also constitute one of the aforementioned frame members 940. As shown, the first portion 920 and the second portion 930 can define an angle 907 therebetween. As shown, the angle 907 can measure 90 degrees. The angle 907, and therefore also the position or orientation of the second portion 930 with respect to the first portion 920, can be adjustable or collapsible by or upon, for example and without limitation, removal of the fasteners 990 shown coupling the second portion 930 to the first portion 920 and/or removal of the support member 1030a,b. At least two of the plurality of moving elements 950 can be positioned on each side of the carriage assembly 120 and, more specifically, the frame 910 thereof.

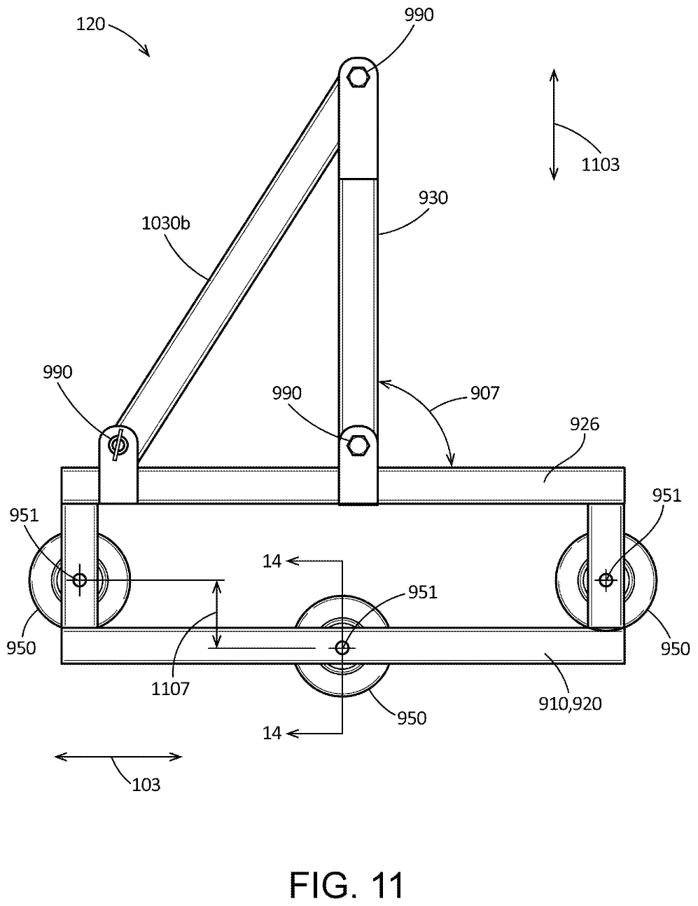

FIG. 11 is a side view of the carriage assembly 120 of FIG. 1A. As shown, the axis 951 of one of the plurality of moving elements 950 can be offset or staggered in a direction parallel to an extension direction 1103 of the second portion 930 of the carriage assembly 120 from the axis 951 of another of the plurality of moving elements 950 by an offset distance 1107.

FIG. 12 is a rear view of the carriage assembly 120 of FIG. 1A. As shown, the axes 951 of the moving elements 950 on opposite sides and, more specifically, opposing legs 927a,b of the frame 910 can be aligned with each other. As also shown, the moving elements 950 on each side of the frame 910 and, more specifically, a centerline of each can be aligned with each other along the longitudinal direction 103. A spacing 954 between axially facing inner surfaces of the moving elements 950 can be greater than or equal to the lateral width 214 of the track members 110a,b to facilitate receipt of the track members 110a,b and, more generally, the track assembly 110 within the track cavity 980. A spacing 952 between axially innermost surfaces of the moving elements 950 can be less than or equal to the lateral width 214 of the track members 110a,b to facilitate engagement of the carriage assembly 120 with the track members 110a,b and, more generally, the track assembly 110. Again, the carriage assembly 120 can define the centerline 1201.

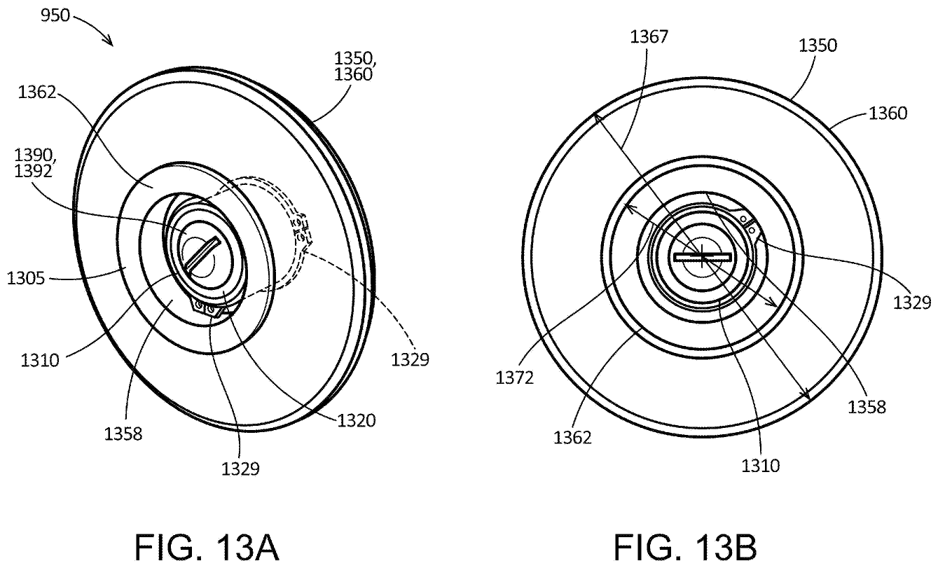

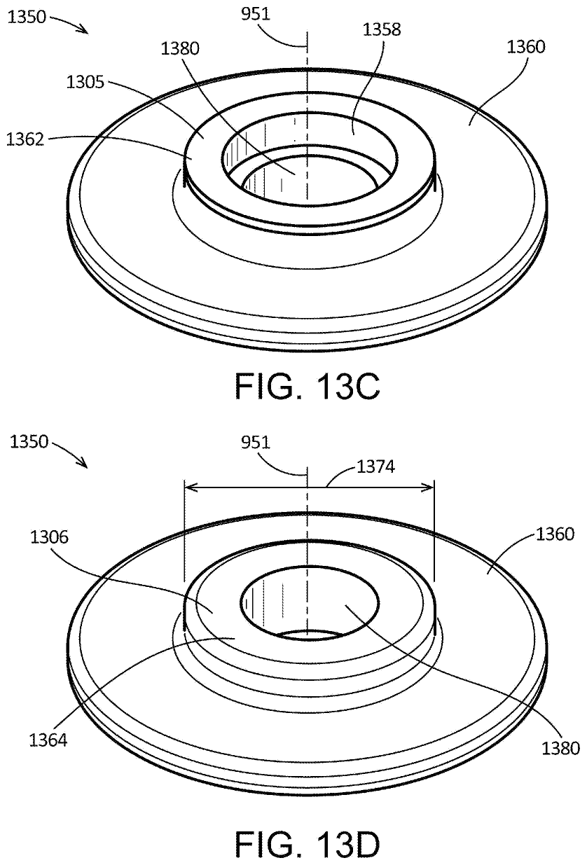

FIGS. 13A-13D illustrate the moving element 950 of the carriage assembly 120 of FIG. 1A. FIG. 13A is specifically an outside perspective view and FIG. 13B is a side view of the moving element 950. The moving element 950 can comprise a hub 1310 and a wheel 1350. In some aspects, as shown, the hub 1310 can be separate from the hub 1310. In some aspects, the hub 1310 can be a monolithically formed central portion of the moving element 950. The moving element 950 can further comprise a fastener 1390, which can secure the moving element 950 to the frame 910 (shown in FIG. 12). At least a first portion or head 1392 of the fastener 1390 can be received within an axial end cavity 1358 defined in the wheel 1350. A second portion or shaft (not shown) of the fastener 1390, which can be threaded, can be received at least partially within a main bore 1380 (shown in FIG. 13C) of the moving element 950 and, more specifically, the wheel 1350. The second portion of the fastener 1390 can be configured to be received within the frame 910 (shown in FIG. 12). The hub 1310 can comprise an anti-friction assembly 1320. The hub 1310 can comprise one or more fasteners 1329, which can secure the anti-friction assembly 1320 and, more generally, the hub 1310 inside the wheel 1350. Each of the one or more fasteners 1329 can be a snap-ring or locking ring and can be received within an annular groove defined proximate to one or both axial ends of the anti-friction assembly 1320.

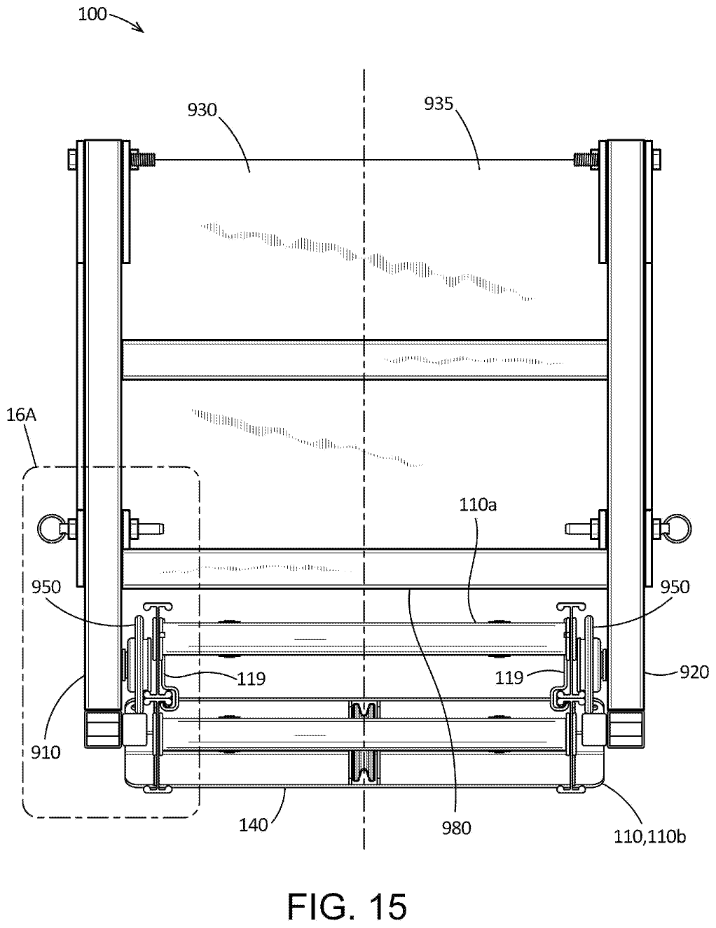

The wheel 1350 can comprise a guide disc 1360, which can define a diameter 1367 (shown in FIG. 13B). The wheel 1350 can comprise a first axial protrusion 1362, which can extend from the guide disc 1360 and towards the track assembly 110 (shown in FIG. 15) in an assembled condition of the carriage assembly 120 and can define an inboard axial end or engagement end or first end 1305 of the moving element 950 and, more specifically, the wheel 1350. The wheel 1350 can comprise a second axial protrusion 1364, which can extend from the guide disc 1360 and towards the frame 910 in an assembled condition of the carriage assembly 120 (shown in FIG. 15) and can define an outboard axial end or mounting end or second end 1306 (shown in FIG. 13D) of the moving element 950 and, more specifically, the wheel 1350. The first axial protrusion 1362 of the wheel 1350 can define a diameter 1372, which can be less than the diameter 1367. The second axial protrusion 1364 of the wheel 1350 can define a diameter 1374 (shown in FIG. 13D), which can itself be less than the diameter 1367. The diameters 1372, 1374 can be equal.

FIG. 13C is an inside perspective view and FIG. 13D is an outside perspective view of the wheel 1350 of the moving element 950. As shown, the first axial protrusion 1362 can define a concave surface. More specifically, as shown in FIG. 15, a radially outer surface of the first end 1305 of the moving element 950 can define a concave shape, which can be configured to receive the enlarged portion 650 (shown in FIG. 6A) of the first rails 210a,b (shown in FIG. 6B) and the second rails 220a,b (shown in FIG. 6B) of the track members 110a,b (shown in FIG. 6B). As shown in FIG. 13D, a radially outer surface of the second axial protrusion 1364 can define a cylindrical shape. Each of or either of the axial end cavity 1358 and the main bore 1380 can define a cylindrical surface.

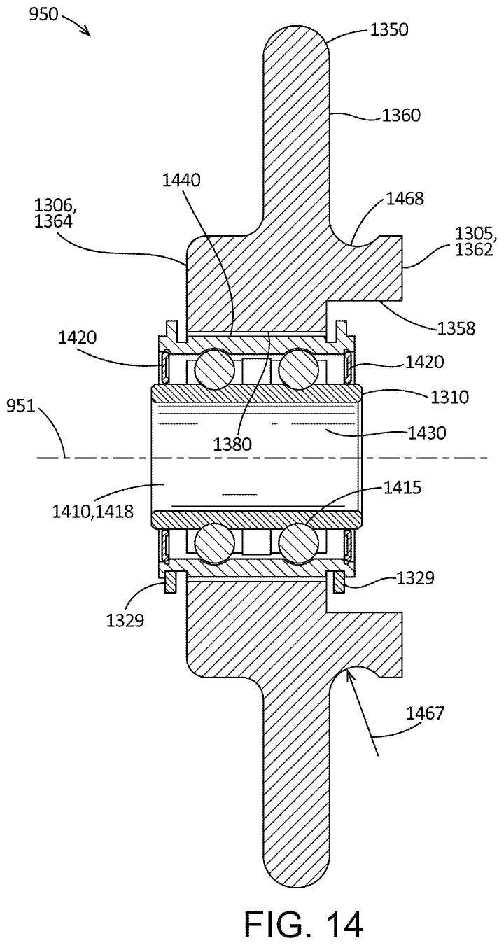

FIG. 14 is a sectional view of the moving element 950 of FIG. 13A taken along line 14-14 of FIG. 11. The hub 1310 and, more specifically, the anti-friction assembly 1320 can comprise a bearing assembly 1410. In some aspects, as shown, the bearing assembly 1410 can comprise ball bearings 1415, which can be lubricated with a lubricating fluid (not shown) sealed within the bearing assembly 1410 with seals 1420. The bearing assembly 1410 can further comprise an inner race 1430 and an outer race 1440. In some aspects, the bearing assembly 1410 can comprise another type of bearings, e.g., roller bearings. The hub 1310 can define a hub bore 1418, which can be sized to receive the fastener 1390 (shown in FIG. 13A). The first axial protrusion 1362 can define the annular groove 1468, which can define a radius 1467 and can be sized to match the radius 657 (shown in FIG. 6A) of the first rails 210a,b (shown in FIG. 6B) and the second rails 220a,b (shown in FIG. 6B) of the track members 110a,b (shown in FIG. 6B).

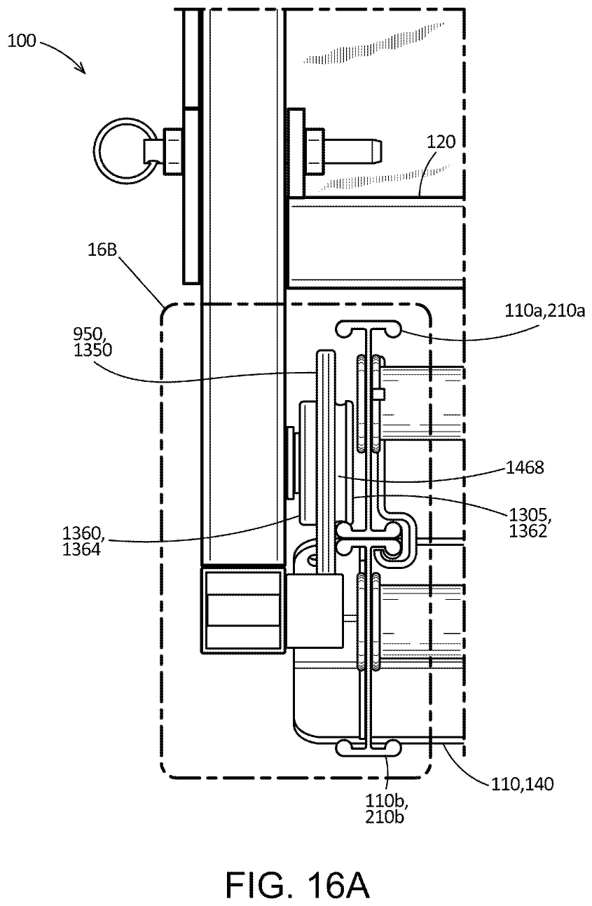

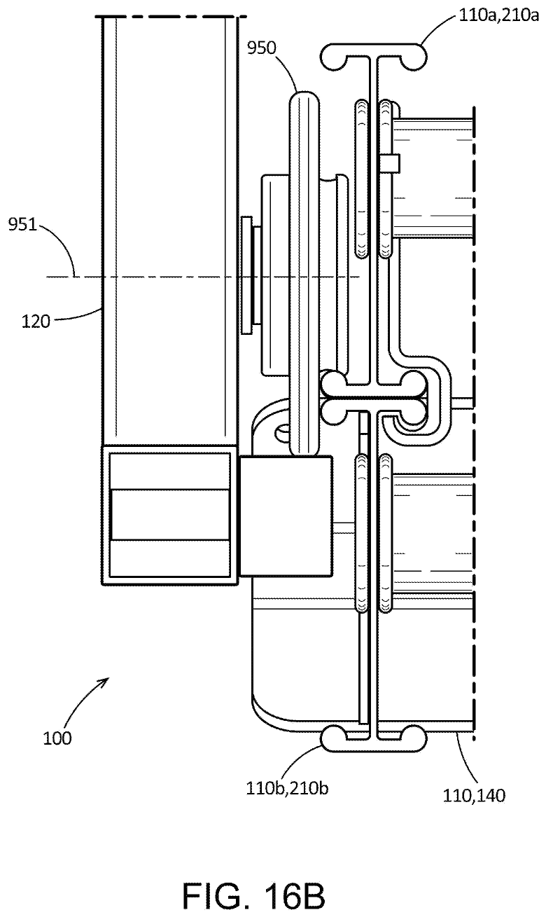

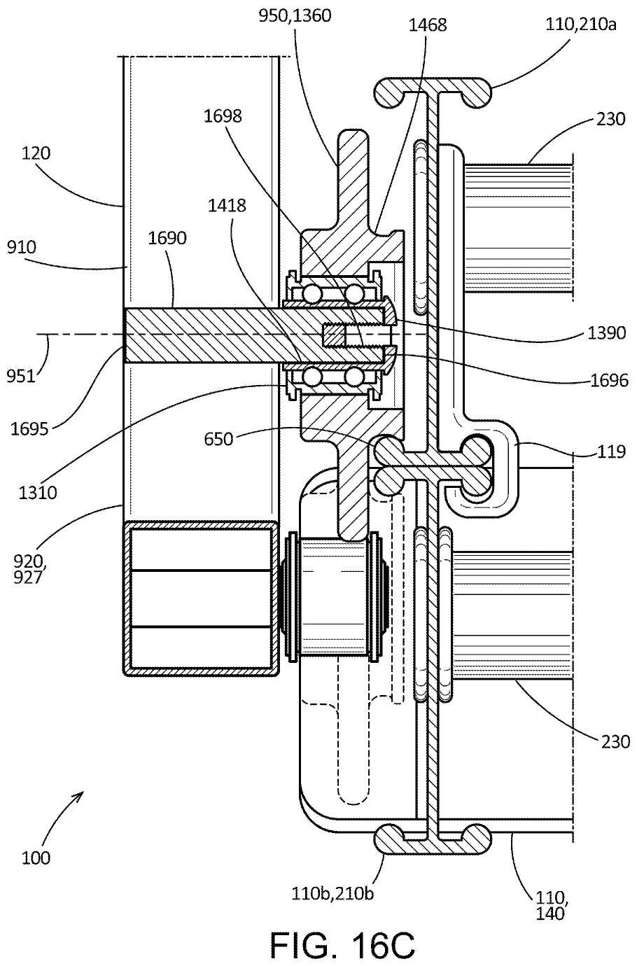

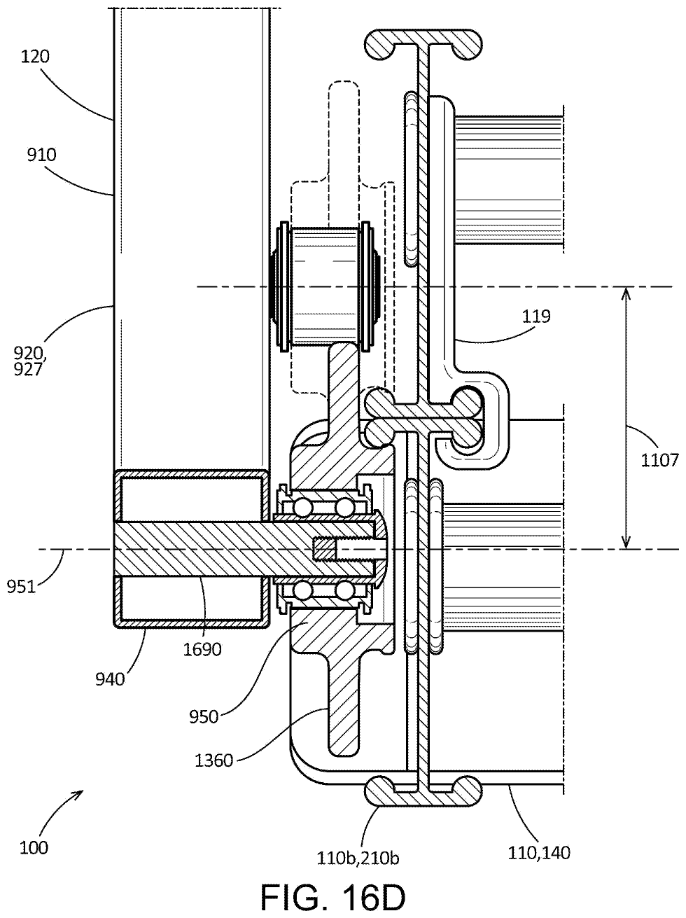

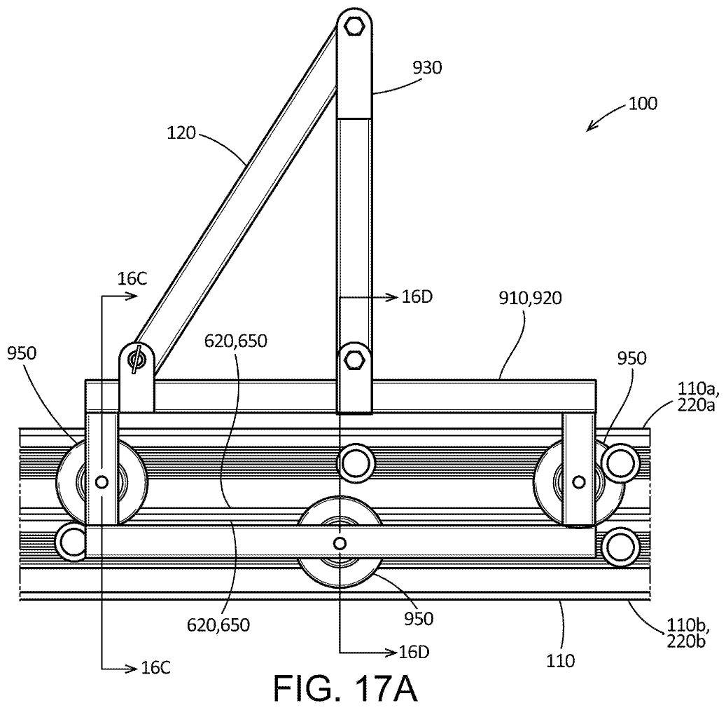

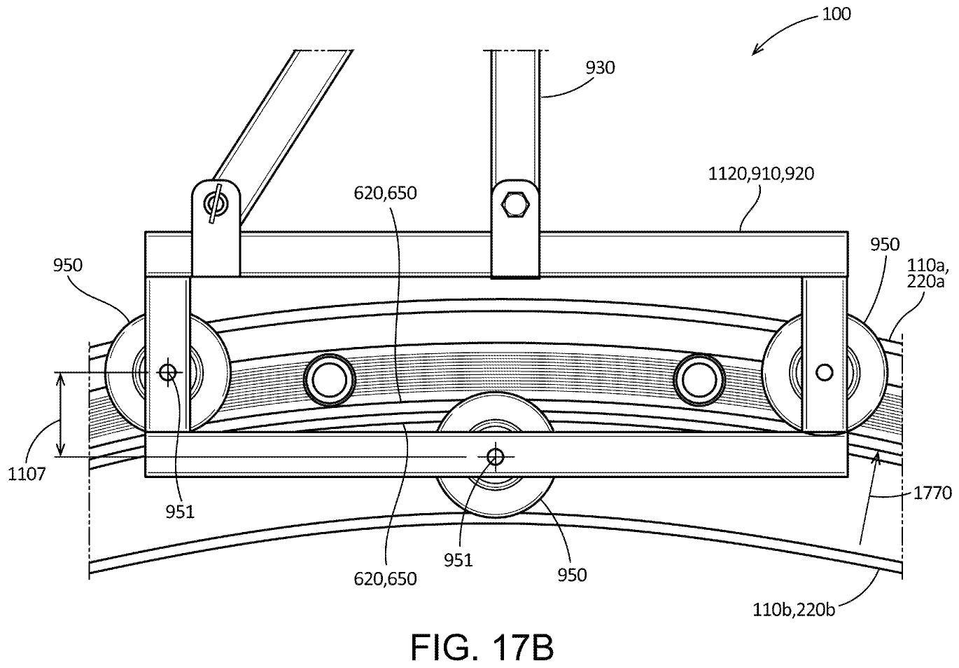

FIG. 15 is a bottom perspective view of the material hoist system 100 of FIG. 1A showing the carriage assembly 120 received about and engaged with the track assembly 110, FIG. 16A is a detail bottom view of the material hoist system 100 of FIG. 1A taken from detail 16A of FIG. 15, and FIGS. 16B-16D are detail bottom views of the material hoist system 100 of FIG. 1A taken from detail 16B of FIG. 16A (with FIGS. 16C and 16D also being taken along lines 16C-16C and 16D-16D, respectively, of FIG. 17A). As shown, a shape of a surface of the inboard axial end 1305 (shown in FIG. 16A) of at least one of the moving elements 950 and, more specifically, a shape of the groove 1468 of the first axial protrusion 1362 of the moving element 950 can match a shape of a surface of a corresponding track member 110a,b. Note that any apparent misalignment visible between the moving element 950 and the mating portions of the track assembly 110 as drawn can be the result of “play” or adjustability in an axial direction with respect to the axis 951 (shown in FIG. 16B) of the wheel 1350 or with respect to the hub 1310. During operation, each wheel 1350 (FIG. 16A) of the moving element 950 and, more specifically, the groove 1468 (shown in FIG. 16A) defined therein can be configured to automatically align with and “track” a mating surface (e.g., the enlarged portion 650 shown in FIG. 16C).

Each of or any of the moving elements 950 can be mounted to a fastener 1690 (shown in FIG. 16C), which can be received within or otherwise mounted to the frame 910 and can define a first axial end 1695 and a second axial end 1696. The fastener 1690, which can be a shaft defining a cylindrical outer surface, can be sized to be received within the moving element 950 and, more specifically, the hub bore 1418 defined therein. The fastener 1390 can secure the moving element 950 to the fastener 1690 and, more specifically, can be received within a threaded bore 1698 defined in the second axial end 1696 of the fastener 1690.

As shown in FIG. 16D, the offset distance 1107 (also shown in FIG. 11) can be set to capture the first rails 210a,b between two upper moving elements 950 and one lower moving element 950 or between one upper moving element 950 and two lower moving elements 950—or in any other desired combination of moving elements 950 configured to slidably couple to the track assembly 110. As shown again, the clamp 119 can itself hold the first rails 210a,b together, as part of the track assembly 110 and with or without the carriage assembly 120 in position.

Similarly, the offset distance 1107 on an opposite side of each of the track assembly 110 and the carriage assembly 120 can be set to capture the second rails 220a,b between two upper moving elements 950 and one lower moving element 950 or between one upper moving element 950 and two lower moving elements 950—or in any other desired combination of moving elements 950 configured to slidably couple to the track assembly 110. Similarly as well, the clamp 119 can hold the second rails 220a,b together, again with or without the carriage assembly 120 in position.

FIG. 17A is a side view of the material hoist system 100 of FIG. 1A showing the carriage assembly 120 engaged with the track assembly 110, wherein the track assembly 110 and, more specifically, the rails 210,220 thereof are straight or rectilinear when viewed from the side. The first flanges 620 and, more specifically, the enlarged portions 650 of the respective first flanges 620 of the second rails 220a,b are captured between the upper and lower moving elements 950, which are fixed in their positions by the frame 910 of the carriage assembly 120.

FIG. 17B is a side view of the material hoist system 100 of FIG. 1A showing the carriage assembly 120 engaged with the track assembly 110, wherein the track assembly 110 and, more specifically, the rails 210,220 thereof are curved when viewed from the side. Again, the first flanges 620 and, more specifically, the enlarged portions 650 of the respective first flanges 620 of the second rails 220a,b are captured between the upper and lower moving elements 950. Because of the curve defining a radius 1770 in the second rails 220a,b at an interface between the second rails 220a,b (and similarly, in the first rails 210a,b at an interface between the first rails 210a,b shown in FIG. 15), the offset distance 1107 can be reduced to ensure that the moving elements 950 remain in continuous contact with the track assembly 110. The offset distance 1107 can be adjusted by adjusting the position of the moving elements 950 on the frame 910.

FIG. 18 is a side view of the material hoist system 100 comprising the track assembly 110, the carriage assembly 120, and the drive assembly 130 in accordance with another aspect of the current disclosure. As shown, the second portion 930 of the carriage assembly 120 can be in a lowered or retracted position and the flexible connecting element 150 can extend from the drive assembly 130 to the carriage assembly 120. More specifically, the flexible connecting element 150 can be coupled to the adapter 1890 of the carriage assembly 120 and can be coupled to a drum (not shown) of the drive assembly 130 through an opening defined in the drive assembly 130. As shown, the flexible connecting element 150 can pass through the guide assembly 140, which can be coupled to the second end 116b or can define the second end 116b of the second track member 110b.

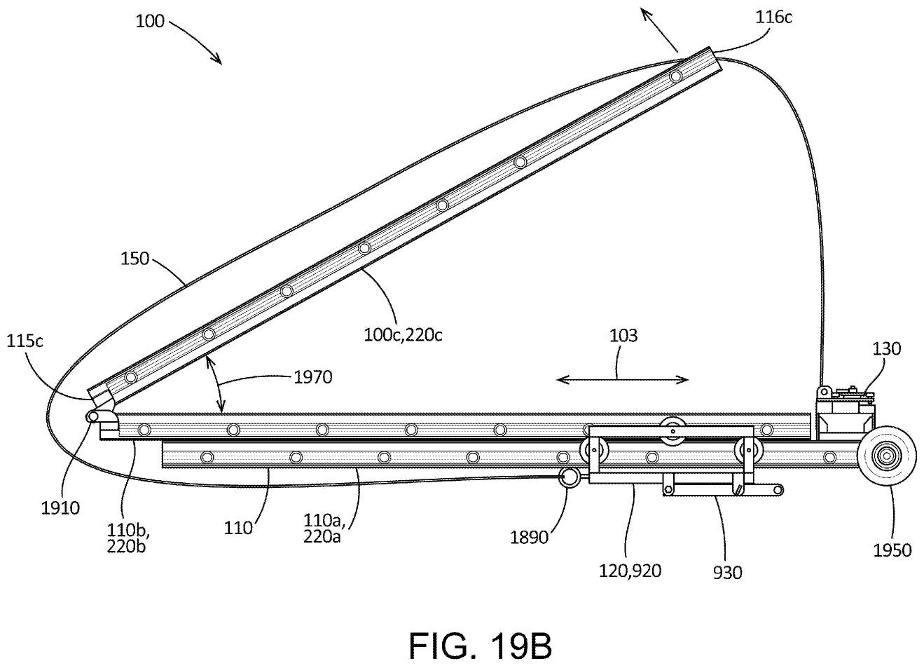

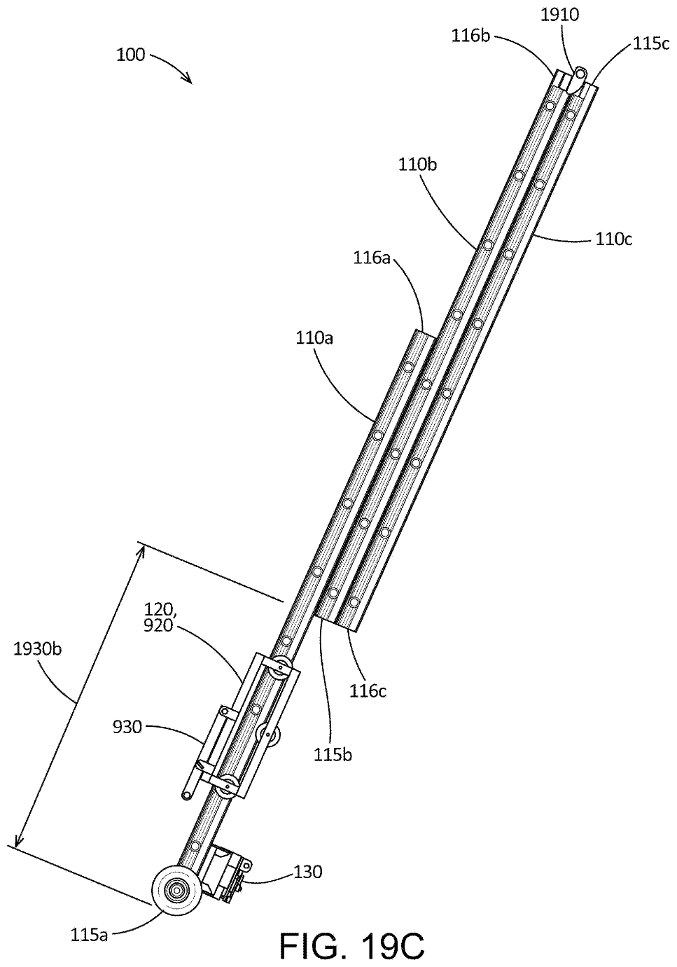

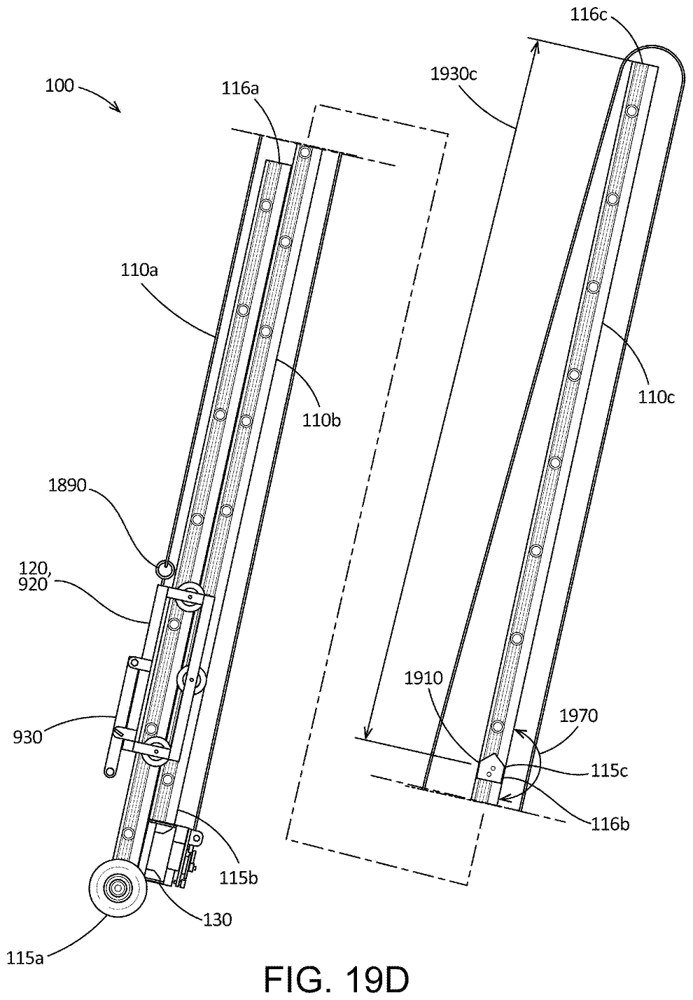

FIG. 19A is a side view of the material hoist system 100 in a fully retracted position in accordance with another aspect of the current disclosure. Again, the material hoist system 100 can comprise the track assembly 110, the carriage assembly 120, and the drive assembly 130. As shown, the second portion 930 of the carriage assembly 120 can be in the lowered or retracted position, and the flexible connecting element 150 is removed for clarity. The track assembly 110 can comprise a third track member 110c, which in some aspects can be rotatably coupled or hingedly secured to the second track member 110b via a hinge 1910.

The third track member 110c can define a bottom end or first end 115c and a top end or second end 116c, which can be distal from the first end 115c. The track member 110c—and any subsequent track members beyond the third track member 110c, including with respect to other descriptions of the third track member 110c disclosed herein—can comprise a first beam or rail 210c and a second beam or rail 220c. Each of the first rail 210c and the second rail 220c can define a first end and a second end, which can be distal from the first end. The first rail 210c (not shown) and the second rail 220c can be parallel to each other and to the longitudinal direction 103. Each of the first rail 210c and the second rail 220c can define a length, which in some aspects can be at least 4 feet. In some aspects, the length of the first rail 210c and the second rail 220c and, more generally, the track member 110c can be at least 8 feet. In some aspects, the length of the first rail 210c and the second rail 220c and, more generally, the track member 110c can be at least 12 feet. In some aspects, the length of each of the second track member 110b, the third track member 110c and subsequently added track members can be shorter or longer than the length of the first track member 110a. In some aspects, each of the first rail 210c and the second rail 220c can be formed monolithically. In some aspects, each of the first rails 210c and the second rail 220c can be formed from multiple pieces or sections, e.g., by fastening or welding. The track member 110c can define a lateral width or width (not shown but similar to the widths 114,214 shown in FIGS. 1 and 2, respectively), which can be at least 18 inches, plus or minus 6 inches. The track member 110c can comprise a plurality of cross members or rungs 230, which can extend from the first rail 210c to the second rail 220c. The plurality of rungs 230 can be spaced apart from each other and distributed along the length 213 (shown in FIG. 2) of the corresponding track member 110c. More specifically, the rungs 230 can be as discussed with respect to the track members 100a,b. The track assembly 110 can comprise the guide assembly 140, which can be secured to the third track member 110c.

In some aspects, the second track member 110b, the third track member 110c, and any additional track members can be joined or, more specifically, spliced to the first track member 110a and/or each other. More specifically, any two track members 110a,b,c can be spliced to each other with one or more splices or splice plates 109 such as, for example and without limitation, shown more specifically in U.S. Provisional Application Nos. 63/439,541, filed Jan. 17, 2023. Any two or more track members 110a,b,c can be configured to remain stationary in all directions with respect to each other such that they function together as a single track 110. The track 110 can be portable. More specifically, the track 110 can be configured to set up only temporarily at a particular location and be able to use and then remove without any tools and without modification of the elevated structure 50.

The material hoist system 100 can comprise a transport wheel 1950, which can facilitate transport and adjustment of the system 100. In some aspects, the wheel 1950 can be locked against rotation such that, during use, the bottom end 115 of the track assembly 110 of the system 100 does not move relative to the first position or ground 40 (shown in FIG. 1A). For example and without limitation, a simple wedge, with can be in the form of an L-shaped bracket turned upside down (i.e., with a bend joining legs of the bracket pointing up), can wedge against the wheel and lock it. The system 100 can comprise a plurality of transport wheels 1950, one of which can be secured to each rail 210,220.

FIG. 19B is a side view of the material hoist system 100 of FIG. 19A between the fully retracted position and an extended position. An open angle 1970 can be defined between the third track member 110c and the second track member 110b. As shown, the open angle 1970 is approximately 30 degrees.

FIG. 19C is a side view of the material hoist system 100 of FIG. 19A with the third track member 110c in the retracted position and the second track member 110b in the extended position. As shown, the first end 115b of the second track member 110b can be offset from the first end 115a of the first track member 110a by a first extension distance 1930b and the height 170 (shown in FIG. 1B) that is reachable by the track assembly 110 can be extended.

FIG. 19D is a side view of the material hoist system 100 of FIG. 19A with the second track member 110b in the retracted position and the third track member 110c in the extended position. In a fully open position, as shown, the open angle 1970 can measure 180 degrees. As shown, the second end 116b of the third track member 110c can be offset from the second end 116b of the second track member 110b by a second extension distance 1930c and the height 170 (shown in FIG. 1B) that is reachable by the track assembly 110 can be extended.

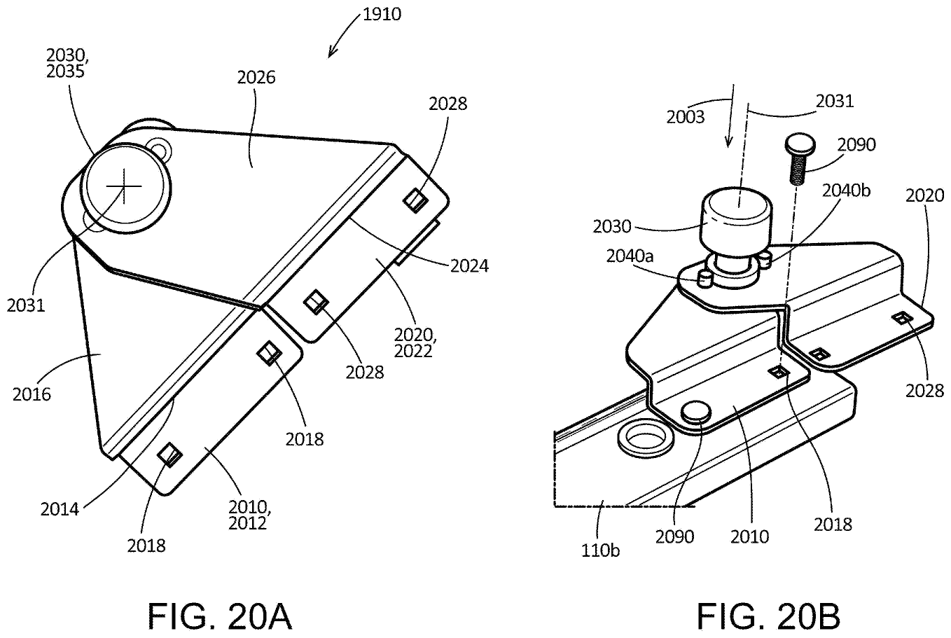

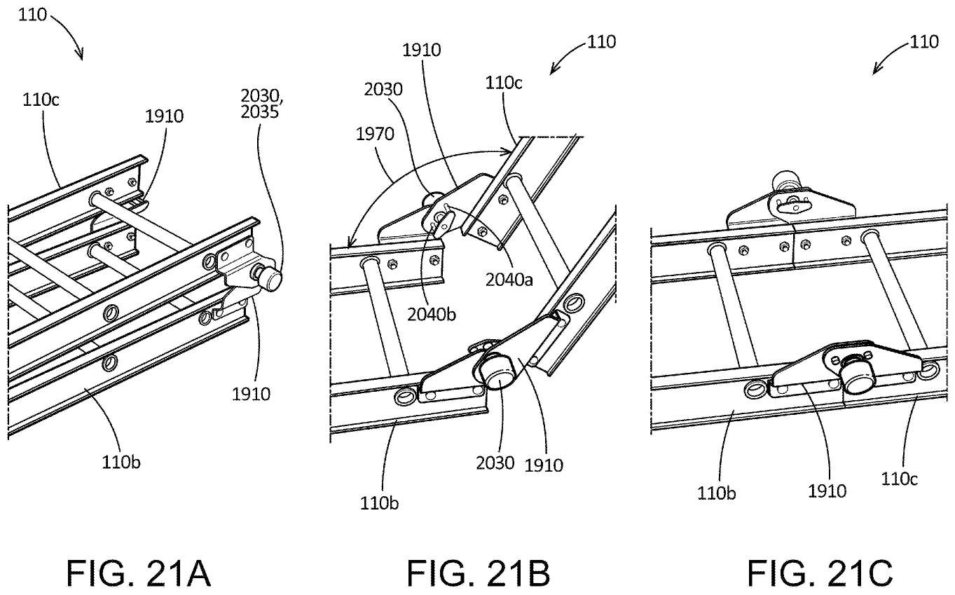

FIGS. 20A-21C illustrate the hinge 1910 of the track assembly 110 of FIG. 19A. FIG. 20A is specifically a side perspective view of the hinge 1910. The hinge 1910 can comprise a first portion 2010 joined to one track member such as the second track member 110b (shown in FIG. 21A) and a second portion 2020 joined to another track member such as the third track member 110c (shown in FIG. 21A). Each of or either of the first portion 2010 and the second portion 2020 can comprise mounting flanges 2012,2022 and working flanges 2016,2026, respectively. The respective mounting flanges 2012,2022 can be joined to the working flanges 2016,2026 with connecting flanges 2014,2024 and can be offset from each other along a direction of the axis 2031 to provide clearance for the flanges 620 of the first rails 210a,b (shown in FIG. 21A) and the second rails 220a,b (shown in FIG. 21A) during assembly.

The first portion 2010 and the second portion 2020 of the hinge 1910 can be joined to each other with a hinge lock 2030. By pushing a knob 2035 of the hinge lock 2030 in a direction towards the first portion 2010 and the second portion 2020 along an axis 2031 of the hinge lock 2030, the hinge lock 2030 can be disengaged and the second portion 2020 can be rotated with respect to the first portion 2010. More specifically, pushing of the knob 2035 in a disengagement direction or direction 2003 can push pins 2040a,b (shown in FIG. 20B) away from the second portion 2020. By releasing the knob 2035 in a direction away from the first portion 2010 and the second portion 2020 back along the axis 2031 of the hinge lock 2030, the hinge lock 2030 can be re-engaged and a rotational position of the second portion 2020 can be locked with respect to the first portion 2010. More specifically, release of the knob 2035 can draw the pins 2040a,b back towards and through the second portion 2020 to mechanically lock the rotational position of the second portion 2020 with respect to the first portion 2010. Rotation can be possible only by again disengaging the hinge lock 2030 or by shearing of the pins 2040a,b, which can be avoided by making the pins 2040a,b sufficiently strong. The first portion 2010 and the second portion 2020 can define respective openings 2018,2028 for mounting the hinge 1910 to any two track members such as, for example and without limitation, the track members 110b,c. The hinge lock 2030 can be, for example and without limitation, a Model 36-32 series hinge lock from WernerCo.

FIG. 20B is a side perspective view of the hinge 1910 of the track assembly 110 of FIG. 19A during assembly to the second track member 110b. As shown, each of the first portion 2010 and the second portion 2020 can be joined to one side the respective track members 110b,c (track member 110c shown in FIG. 21A) with fasteners 2090 through openings 2018,2028 defined in the portions 2010,2020 and through matching openings defined in the track members 110b,c.

FIGS. 21A-21C illustrate a process of opening the track assembly 110 assembled with the hinge 1910. FIG. 21A is specifically a side perspective view of the track assembly 110 showing the hinge 1910 of the track assembly 110 in a retracted position. FIG. 21B is a side perspective view of the track assembly 110 of FIG. 21A showing the hinge 1910 between the retracted position of FIG. 21A and an extended position shown in of FIG. 21C. As shown, the open angle 1970 can measure between 0 and 180 degrees during this step. FIG. 21C is a side perspective view of the track assembly 110 of FIG. 21A showing the hinge in the extended position.

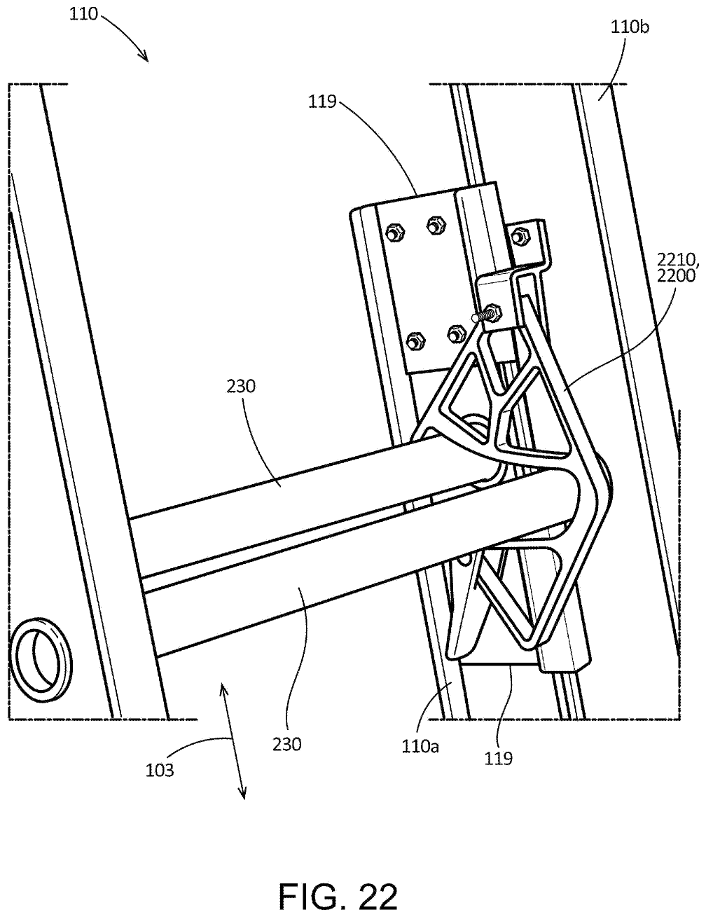

FIG. 22 is a side perspective view of a track lock assembly 2200 of the track assembly 110 of FIG. 1A. The track lock assembly 2200 can be fixed to one of the track members such as, for example and without limitation, the second track member 110b. While sliding the second track member 110b with respect to the first track member 110a, a lever 2210 of the track lock assembly 2200 can snap around the rung 230 of the first track member 110a and lock the track members 110a,b together. The track lock assembly 2200 can be, for example and without limitation, Model 28-11 rung lock kit from WernerCo.

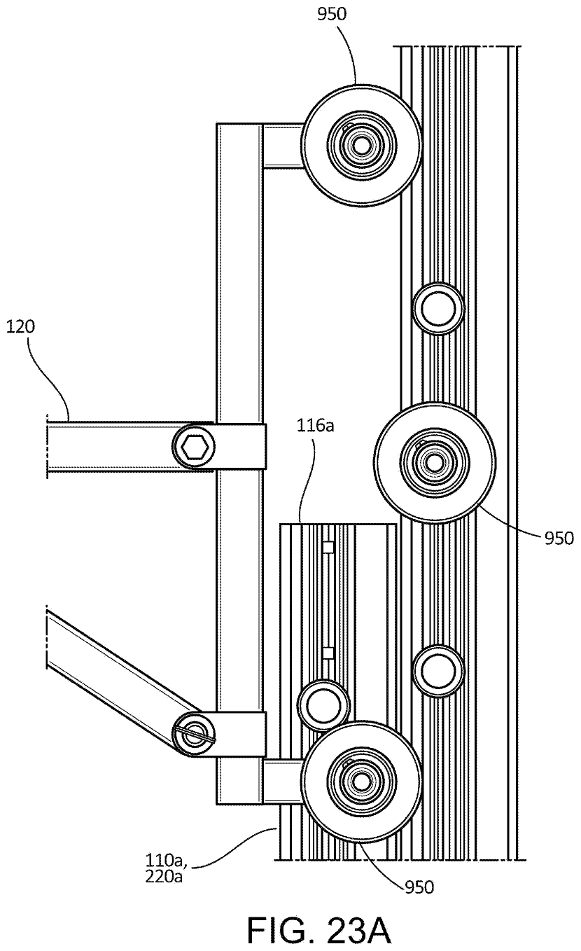

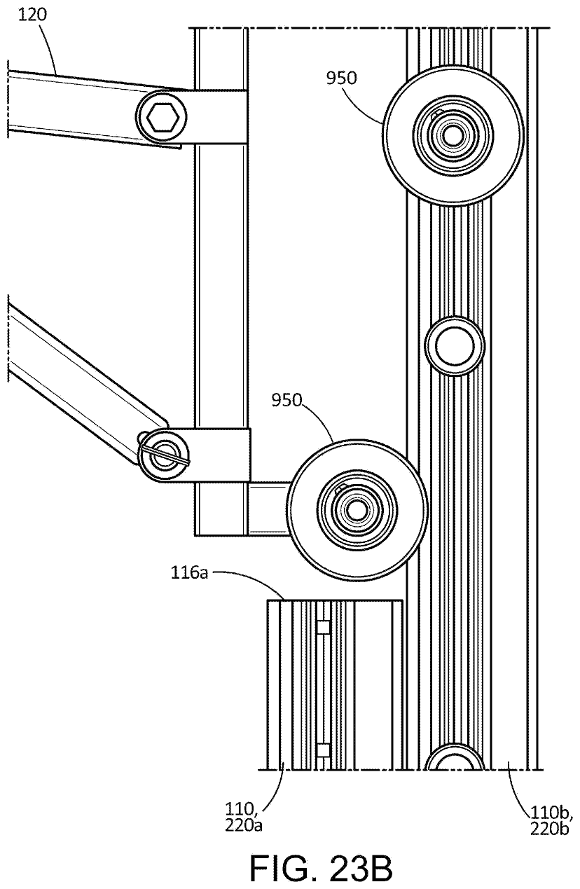

FIG. 23A is a side view of the material hoist system 100 of FIG. 1A taken along line 23-23 of FIG. 1A showing the carriage assembly 120 engaged with the track assembly 110 at an area of transition from the two track members 110a,b to the single track member 110b, and FIG. 23B is a side view of the material hoist system 100 of FIG. 1A taken along line 23-23 of FIG. 1A showing the carriage assembly 120 engaged with the track assembly 110 at an area of the track assembly comprising only the single track member 110b. While engagement of the carriage assembly 120 with a single flange 620 of the second track member 110b instead of the two flanges 620 of the track members 110a,b can result in a slightly looser fit of the carriage assembly 120 on the track assembly 110, the carriage assembly 120 can nonetheless remain slidably engaged with the track assembly 110. The presence of the two moving elements 950 in the upper positions, i.e., on top of the flange 620 can result in two points of contact between the two moving elements 950 and the flange 620 on each side of the track member 110b: two points of contact between the two moving elements 950 and the flange 620 of the first rail 210b and two points of contact between the two moving elements 950 and the flange 620 of the second rail 220b. More generally, the plurality of moving elements 950 positioned on each side of the carriage assembly 120 can be configured to engage the first track member 110a alone, the second track member 110b alone, the third track member 110c alone, or any two of the track members 110a,b,c simultaneously.

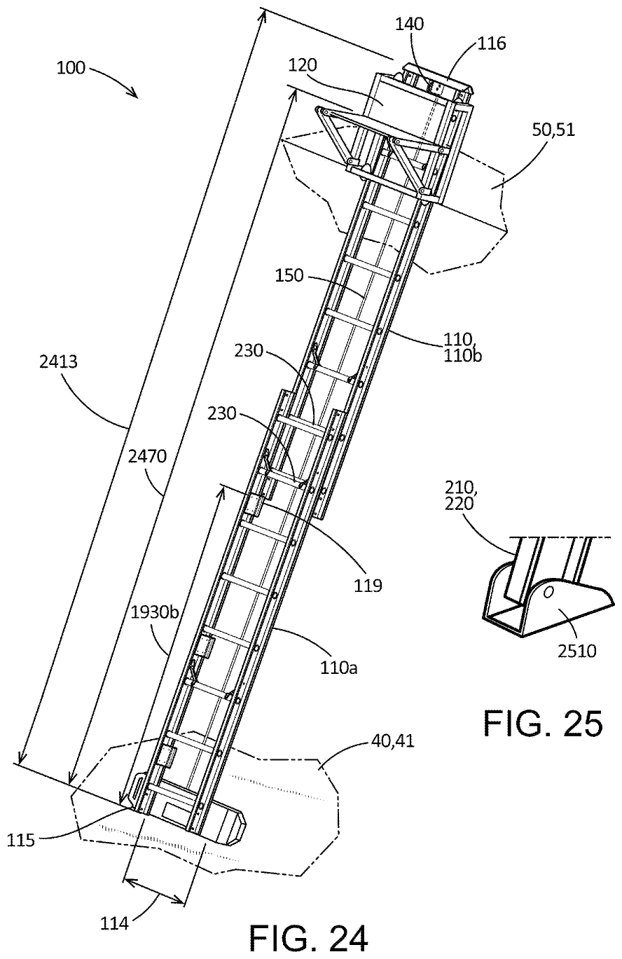

FIG. 24 is a front perspective view of the material hoist system 100 of FIG. 1A with the carriage assembly 120 positioned proximate to a second end or top end 116 of the track assembly 110. As shown in FIG. 1A, the track assembly 110 is extended, with the track member 110b offset with respect to the track member 110a by the offset distance 1930b. In an extended condition, an overall length 2413 of the track assembly 110 can be significantly increased—by at least the length 213 (shown in FIG. 2) of each of the first track member 110a and the second track member 110b minus the minimum overlap between the first track member 110a and the second track member 110b, which can be an overlap distance corresponding in some aspects to the illustrated overlap of two rungs 230. As shown, operation of the drive assembly 130 can wind up a portion of the flexible connecting element 150 and thereby lift the carriage assembly 120 to a distance 2470 measured from the first end 115. With the carriage assembly 120 now proximate to the elevated structure 50, a user on the elevated surface 51 can remove the load 80 lifted up the track assembly 110 by the system 100.

FIG. 25 is a front perspective view of an exemplary rail 210,220 comprising a foot 2510, which can help stabilize and immobilize the lower end 115 of the track assembly 110 during use.

A method of using the material hoist system 100 can comprise extending an overall length 2413 of the track assembly 110 by slidably moving the second track member 110b of the track assembly 110 with respect to a first track member 110a of the track assembly 110. The method can comprise slidably moving the carriage assembly 120 of the system 100 with respect to the track assembly 110. The method can further comprise extending the overall length of the track assembly 110 by moving the third track member 110c of the track assembly 110 with respect to the second track member 110b. Again, the third track member 110c can be configured to slidably or rotatably move with respect to the second track member 110b. More specifically, the method of extending the overall length 2413 of the track assembly 110 can comprise rotatably moving the third track member 110cc with respect to the second track member 110b.

Various components of the material hoist system 100 can be formed from or comprise a metal such as, for example and without limitation, steel or aluminum or a plastic or other sufficiently strong material. More specifically, the track members 110a,b,c and the carriage assembly and various components thereof such as, for example and without limitation, the first rails 210a,b,c and the second rails 220a,b,c can be formed from any material matching user preferences including a lightweight material such as, for example and without limitation, aluminum. Each of or any of the wheels 1350 can be formed from or can comprise any rigid material such as, for example and without limitation, metal (e.g., aluminum, steel, or cast iron) or plastic (e.g., a reinforced polyamide resin). The frame 910 and, more specifically, the frame members 940 thereof can be formed from structural tubing such as, for example and without limitation, carbon steel or aluminum tubing, which can be hollow and can define a square shape in cross-section. In some aspects, T-slot aluminum profiles and accompanying fasteners such as are available from 80/20, Inc. of Columbia City, Indiana, U.S.A., can be used to construct some or all of the frame 910 and can form the frame members 940 and the various portions of the carriage assembly 120 but with less welding. The flexible connecting element 150 can be any flexible but strong device such as, for example and without limitation, a rope or cable. The flexible connecting element 150 can be formed from any sufficiently strong material such as, for example and without limitation, metal (e.g., wire rope or wire cable or chain) or plastic (e.g., synthetic polyethylene such as high molecular weight polyethylene (HMwPE) or even ultra-high molecular weight polyethylene (UHMwPE) such as the DYNEEMA fiber available in multi-stranded braided AMSTEEL-Blue rope available from Samson Rope Technologies of Ferndale, Washington, U.S.A.). In some aspects, a nominal diameter of the flexible connecting element 150 can measure 3/16 inch, including when using the polyethylene rope material. In some aspects, the diameter can be smaller, including when the flexible connecting element 150 comprises steel cable. Each of or any of the clamps 119 can be formed from any rigid material such as, for example and without limitation, plastic (e.g., a reinforced polyamide resin). In some aspects, the various components can be formed from any other material, any of which can optionally be corrosion-resistant or replaceable for serviceability.

Various components of the material hoist system 100 can be formed from any one or more of a variety of manufacturing processes including subtractive manufacturing processes such as, for example and without limitation, machining, forging, stamping; additive manufacturing processes such as, for example and without limitation, three-dimensional printing; and any other forming and assembly processes such as, for example and without limitation, bending and riveting.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A track assembly comprising:
a first track member; and
a second track member coupled to the first track member, each of the first track member and the second track member comprising:
a first rail; and
a second rail, each of the first rail and the second rail defining a first end and a second end distal from the first end;
wherein:
a first flange of the first rail of the first track member is in facing contact with a first flange of the first rail of the second track member;
a first flange of the second rail of the first track member is in facing contact with a first flange of the second rail of the second track member;
an overall length of the track assembly is adjustable, the second track member configured to move with respect to the first track member; and
the track assembly is configured to slideably receive a carriage assembly configured to support a load.

2. The track assembly of claim 1, further comprising:
at least one first clamp secured to the first rail of the first track member and engaged with the first rail of the second track member; and
at least one second clamp secured to the second rail of the first track member and engaged with the second rail of the second track member.

3. The track assembly of claim 2, wherein:
the at least one first clamp is configured to hold the first flange of the first rail of the first track member in facing contact with the first flange of the first rail of the second track member; and
the at least one second clamp is configured to hold the first flange of the second rail of the first track member in facing contact with the first flange of the second rail of the second track member.

4. The track assembly of claim 1, further comprising a guide assembly configured to guide passage of a flexible connecting element therethrough.

5. The track assembly of claim 1, further comprising a third track member secured to the second track member.

6. The track assembly of claim 5, wherein the rails of at least one of the first track member and the second track member are curved when viewed from the side.

7. A material hoist system comprising the track assembly of claim 1, further comprising a drive assembly configured to wind and unwind a flexible connecting element attached to a carriage assembly, the track assembly configured to slidably receive the carriage assembly.

8. The material hoist system of claim 7, wherein the drive assembly is fixed in a stationary position on the track assembly and is configured to not move during operation of the material hoist system.

9. The material hoist system of claim 7, further comprising the carriage assembly.

10. A carriage assembly comprising:
a frame comprising:
a first portion configured to slidably secure to a track member of a track assembly, the track assembly comprising:
a first track member; and
a second track member slidably coupled to the first track member; and
a second portion coupled to the first portion and configured to be angled with respect to the first portion; and
a plurality of moving elements secured to the frame.

11. The carriage assembly of claim 10, wherein each of the plurality of moving elements comprises a bearing.

12. The carriage assembly of claim 11, wherein at least two of the plurality of moving elements are positioned on each side of the carriage assembly, the at least two of the plurality of moving elements positioned on each side of the carriage assembly configured to engage the first track member alone, the second track member alone, or both of the first track member and the second track member simultaneously.

13. The carriage assembly of claim 11, wherein an axis of one of the plurality of moving elements is offset in a direction parallel to an extension direction of the second portion of the carriage assembly from an axis of another of the plurality of moving elements.

14. The carriage assembly of claim 11, wherein a shape of a surface of an inboard axial end of each of the plurality of moving elements matches a shape of a surface of each of the first track member and the second track member.

15. The carriage assembly of claim 11, wherein the surface of the inboard axial end of each of the plurality of moving elements defines a concave shape.

16. The carriage assembly of claim 10, wherein a position of the second portion with respect to the first portion is adjustable or collapsible.

17. The carriage assembly of claim 16, wherein the position of the second portion with respect to the first portion is adjustable or collapsible upon removal of a fastener coupling the second portion to the first portion.

18. A method of using a material hoist system, the method comprising:
extending an overall length of a track assembly by slidably moving a second track member of the track assembly with respect to a first track member of the track assembly; and
slidably moving a carriage of the system with respect to the track assembly.

19. The method of claim 18, further comprising extending the overall length of the track assembly by adding a third track member of the track assembly.

20. The method of claim 19, wherein extending the overall length of the track assembly comprises splicing the third track member to one of the first track member and the second track member.
